(19) United States
(12) Patent Application Publication
(10) Pub. No.: US 2026/0015454 A1
(43) Pub. Date: Jan. 15, 2026

(54) HIGH PERFORMANCE, AMBIENT CURE POLYURETHANES COMPRISING POLYCAPROLACTONE POLYOLS

(71) Applicant: INGEVITY UK LTD, Cheshire (GB)

(72) Inventors: Scott D. Phillips, Cheshire (GB); Anthony Maher, Cheshire (GB); Joel Neale, North Charleston, SC (US)

(21) Appl. No.: 19/263,087

(22) Filed: Jul. 8, 2025

Related U.S. Application Data
(60) Provisional application No. 63/669,072, filed on Jul. 9, 2024.

(51) Int. Cl. C08G 18/66; C08G 18/32; C08G 18/42; C08G 18/79

(52) U.S. Cl. CPC C08G 18/664; C08G 18/3206; C08G 18/4277; C08G 18/797; C08G 2110/0083

(57) ABSTRACT

The present disclosure provides polymeric composition that includes a reaction product of: polycaprolactone co-polyol that includes a reaction product of hydroxyl-functional organic compound with ε-caprolactone and ε-caprolactone with one alkyl substituent, wherein the one or more hydroxyl-functional organic compound is present in the range of about 5.0 wt % to about 95.0 wt %, the ε-caprolactone is present in the range of about 5.0 wt % to about 95.0 wt %, the ε-caprolactone with one alkyl substituent is present in the range of about 5.0 wt % to about 95.0 wt %, and has an average molecular weight of about 500 g/mol to about 10,000 g/mol; one or more diisocyanate; and optionally diol chain extender, diamine chain extender, or a combination thereof, having a molecular weight of about 60.0 g/mol to about 600.0 g/mol, with an NCO:OH molar ratio of from about 0.9:1 to about 2:1.

### CROSS-REFERENCE TO RELATED APPLICATIONS

This application claims priority to, and benefit of, U.S. Provisional Patent Application No. 63/669,072, filed 9 Jul. 2024, which is incorporated by reference herein in its entirety for all purposes.

### BACKGROUND

Polyurethanes based on polycaprolactones are characterized by best-in-class mechanical properties, outstanding durability in harsh environmental conditions, and processing case, as compared to many alternative materials. For this reason, such polyurethanes find use in very demanding applications where articles are exposed to high temperatures, humid environments, ultraviolet (UV) light, and repeated mechanicals deformations, such as in industrial seals, gaskets, wheels and rollers, paint protection films, and in automotive suspension systems.

Despite the commercial success of polyurethanes based on polycaprolactone polyols, applications are limited since many polyurethane manufacturers require the polyol to be in liquid form in order to react with isocyanates at ambient temperature. Above approximately 800 g/mol, polycaprolactone diols are solid at ambient temperate and pressure. For polycaprolactone triols and tetrols, products are solid above approximately 1000 g/mol. This can be observed in FIG. 1. This limits the production of polyurethanes based on polycaprolactone polyols to more sophisticated producers who can heat the polyol before reaction with isocyanate, or alternatively the polycaprolactone polyols can only be used as a minority component in formulations where they can be blended into liquid polyols before the reaction to form the polyurethane. In the latter case, the full technical benefits of polycaprolactone polyols cannot be accessed.

Furthermore, a number of polyurethane processors are simply unable to use solid polyol. For example, 1K & 2K polyurethane coatings require all components to be in the liquid form to be applied as a spray at room temperature. Similarly, the large-scale production of flexible polyurethane foams, either as slabstock or moulded items, require all components to be mixed in liquid form at ambient conditions. Polyurethanes that need to be manufactured in proximity to their end use, for example in concrete moulds for construction, cannot pre-heat the components such as the polyol.

A limited number of caprolactone polyols of lower molecular weight exist that are in the liquid form. However, the low molecular weight means that polyurethane articles produced using these polyols will be heavily cross-linked and thus be hard, rigid materials. Technology does not exist to allow the incorporation of higher molecular weight polycaprolactone polyols into polyurethane articles using room temperature processes. Such technology would allow access to more flexible, resilient materials with widespread commercial utility, allowing the unique technical value proposition of polycaprolactone polyols to be accessed.

Copolymerization has been used to modify the properties of polycaprolactone polyols, which can produce liquid products. However, using such polyols often has the unintended effect of compromising the expected technical features of polycaprolactone polyols. For example, random copolymers based on caprolactone and lactide exist in the liquid form at room temperature at least up to a molecular weight of 2000 g/mol. However, these liquid polyols have reduced crystallinity, increased ester-bond density, and increased acidity, resulting in polyurethane end articles that do not exhibit the mechanical performance (e.g., elongation at break and resilience) and durability (e.g., hydrolytic stability) that is unique to polyurethanes based on polycaprolactone polyols.

Thus, there is a need for polyurethane technology based on polycaprolactone polyols that can be manufactured at room temperature and still offer the same technical benefits of polyurethanes produced at higher temperatures (e.g., exceptional mechanical performance, such as flexibility and resilience) and durability (e.g., hydrolytic stability). The present disclosure addresses this need with novel polyurethane compositions based on polycaprolactone polyols that are liquid at room temperature and achieve exceptional mechanical performance and durability that would be anticipated from similar articles produced at elevated temperature.

### SUMMARY

Surprisingly and unexpectedly, it was discovered that novel polyurethane articles based on a class of liquid polycaprolactone co-polyols manufactured at room temperature achieved mechanical properties and durability on par with those produced at elevated temperatures using conventional hot cast polyurethane production methods.

An aspect of the present disclosure provides a polymeric composition comprising, consists essentially of, or consists of a reaction product of: (a) one or more (e.g., 1, 2, 3, 4, or more) polycaprolactone co-polyol, wherein the one or more polycaprolactone co-polyol comprises, consists essentially of, or consists of a reaction product of one or more (e.g., 1, 2, 3, 4, or more) hydroxyl-functional organic compound with ε-caprolactone and one or more (e.g., 1, 2, 3, 4, 5, 6, 7, or more) ε-caprolactone with one alkyl substituent (e.g., a linear or branched C₁₋₁₀ alkyl), wherein (1) the one or more hydroxyl-functional organic compound is present in the range of about 5.0 wt % to about 95.0 wt %, (2) the ε-caprolactone is present in the range of about 5.0 wt % to about 95.0 wt % of the total molecular weight of the polycaprolactone co-polyol, (3) the one or more ε-caprolactone with one alkyl substituent is present in the range of about 5.0 wt % to about 95.0 wt % of the total molecular weight of the polycaprolactone co-polyol, and (4) the one or more polycaprolactone co-polyol is present in the range of about 5.0 wt % to 95.0 wt % of the polymeric composition and has an average molecular weight of about 500 g/mol to about 10,000 g/mol; (b) one or more (e.g., 1, 2, 3, 4, or more) diisocyanate that is present in the range of about 5.0 wt % to 95.0 wt % of the polymeric composition; and (c) optionally at least one of one or more (e.g., 1, 2, 3, 4, or more) diol chain extender, one or more (e.g., 1, 2, 3, 4, or more) diamine chain extender, or a combination thereof, having a molecular weight of about 60.0 g/mol to about 600.0 g/mol, with an NCO:OH molar ratio of from about 0.9:1 to about 2:1, wherein the one or more diol chain extender, the one or more diamine chain extender, or the combination thereof, is present in the range of about 0.0 wt % to 25.0 wt % of the polymeric composition.

An aspect of the present disclosure provides a method of making a polymeric composition, the method comprising, consists essentially of, or consists of reacting: (a) one or more (e.g., 1, 2, 3, 4, or more) polycaprolactone co-polyol, wherein the one or more polycaprolactone co-polyol comprises, consists essentially of, or consists of a reaction product of one or more (e.g., 1, 2, 3, 4, or more) hydroxyl-functional organic compound with ε-caprolactone and one or more (e.g., 1, 2, 3, 4, 5, 6, 7, or more) ε-caprolactone with one alkyl substituent (e.g., a linear or branched C₁₋₁₀ alkyl), wherein (1) the one or more hydroxyl-functional organic compound is present in the range of about 5.0 wt % to about 95.0 wt %, (2) the ε-caprolactone is present in the range of about 5.0 wt % to about 95.0 wt % of the total molecular weight of the polycaprolactone co-polyol, (3) the one or more ε-caprolactone with one alkyl substituent is present in the range of about 5.0 wt % to about 95.0 wt % of the total molecular weight of the polycaprolactone co-polyol, and (4) the one or more polycaprolactone co-polyol is present in the range of about 5.0 wt % to 95.0 wt % of the polymeric composition and has an average molecular weight of about 500 g/mol to about 10,000 g/mol; (b) one or more (e.g., 1, 2, 3, 4, or more) diisocyanate that is present in the range of about 5.0 wt % to 95.0 wt % of the polymeric composition; and (c) optionally at least one of one or more (e.g., 1, 2, 3, 4, or more) diol chain extender, one or more (e.g., 1, 2, 3, 4, or more) diamine chain extender, or a combination thereof, having a molecular weight of about 60.0 g/mol to about 600.0 g/mol, with an NCO:OH molar ratio of from about 0.9:1 to about 2:1, wherein the one or more diol chain extender, the one or more diamine chain extender, or the combination thereof is present in the range of about 0.0 wt % to 25.0 wt % of the polymeric composition.

Another aspect of the present disclosure provides a polyurethane elastomer, a thermoplastic polyurethane, a hot cast elastomer, a cold cast elastomer, a polyurethane foam, a flexible polyurethane foam, a slabstock polyurethane foam, a moulded polyurethane foam, a microcellular polyurethane foam, a polyurethane dispersion in aqueous or organic media, a polyurethane adhesive, a one-component polyurethane coating, a two-component polyurethane coating, an additive manufacturing composition/resin, or a polyurethane sealant, comprising or consisting essentially of the polymeric composition of the present disclosure.

A further aspect of the present disclosure provides a polyurethane elastomer, a thermoplastic polyurethane, hot cast elastomer, cold cast elastomer, polyurethane foam, flexible polyurethane foam, a slabstock polyurethane foam, a moulded polyurethane foam, a microcellular polyurethane foam, a polyurethane dispersion in aqueous or organic media, a polyurethane adhesive, a 1-component polyurethane coating, a 2-component polyurethane coating, an additive manufacturing composition/resin, or a polyurethane sealant, comprising or consisting essentially of the polymeric composition of the present disclosure, wherein the one or more polycaprolactone co-polyol has an average molecular weight of about 500 g/mol to about 10,000 g/mol (e.g., about 800 g/mol to about 10,000 g/mol).

### BRIEF DESCRIPTION OF THE DRAWINGS

The accompanying drawings, which are incorporated into and form a part of the specification, illustrate several embodiments of the present disclosure and, together with the description, serve to explain the principles of the disclosure. The drawings are only for the purpose of illustrating an embodiment of the disclosure and are not to be construed as limiting the disclosure. Further objects, features and advantages of the disclosure will become apparent from the following detailed description taken in conjunction with the accompanying figures showing illustrative embodiments of the disclosure.

FIG. 1 illustrates the effect of molecular weight and functionality has on the physical state (i.e., liquid or solid) of polycaprolactone polyols.

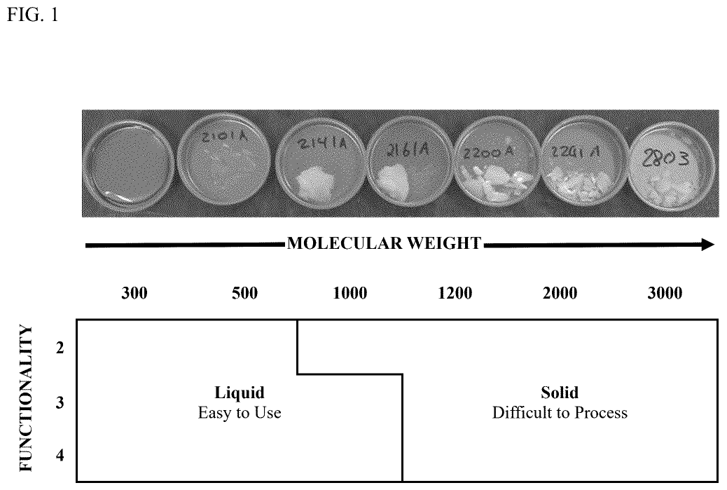

### DETAILED DESCRIPTION OF THE INVENTION

Presently described is a polyurethane composition that can be manufactured at room temperature yet give excellent mechanical properties and durability. Whilst incorporation of polycaprolactone co-polyols with more than 20% of a caprolactone monomer substituted with one alkyl substituent may be anticipated to be liquid and yield polyurethanes at room temperature, conservation of the mechanical properties and durability was wholly unexpected.

Unless otherwise defined, all technical and scientific terms used herein have the same meaning as commonly understood by one of ordinary skill in the art to which this disclosure belongs. The terminology used in the description is for describing particular embodiments only and is not intended to be limiting of the disclosure.

Where a range of values is provided, it is understood that each intervening value in the range, to the tenth of the unit of the lower limit unless the context clearly dictates otherwise (e.g., in the case of a group containing a number of carbon atoms in which case each carbon atom number falling within the range is provided), between the upper and lower limit of that range and any other stated or intervening value in that stated range is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either/or both of those included limits are also included in the disclosure.

It should also be understood that, in certain methods or processes described herein that include more than one step or act, the order of the steps or acts of the method is not necessarily limited to the order in which the steps or acts of the method are recited unless the context indicates otherwise.

The following terms are used to describe the present disclosure. In instances where a term is not specifically defined herein, that term is given an art-recognized meaning by those of ordinary skill applying that term in context to its use in describing the present disclosure.

The articles “a” and “an” as used herein and in the appended claims are used herein to refer to one or to more than one (that is, to at least one or one or more of) of the grammatical object of the article unless the context clearly indicates otherwise. By way of example, “an element” means one element or more than one element, unless otherwise indicated.

The phrase “and/or”, as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, that is, “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (that is, “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended (that is, to mean including but not limited to). It is expressly contemplated that all embodiments, and claims reciting one of the open-ended transitional phrases can be written with any other transitional phrase, which may be more limiting (e.g., “consisting essentially of” or “consisting of”), unless clearly precluded by the context or art. Only the transitional phrases “consisting of” and “consisting essentially of” shall be closed or semi-closed transitional phrases, respectively, as set forth in the United States Patent Office Manual of Patent Examining Procedures, Section 2111.03.

The term “independently” is used herein to indicate that the variable, which is independently applied, varies independently from application to application.

The term “optional” or “optionally”, as used herein, means that the subsequently described event or circumstance may or may not occur, and that the description includes instances where said event or circumstance occurs and instances where it does not.

The term “alkyl” shall mean within its context a linear, branch-chained or cyclic fully saturated hydrocarbon radical, such as a C₁-C₁₅, a C₁-C₁₀, a C₁-C₆, a C₁-C₅, or a C₁-C₃ alkyl group, which is optionally substituted with any suitable functional group or groups (e.g., optionally substituted as described herein). Examples of alkyl groups are methyl, ethyl, butyl, n-butyl, sec-butyl, pentyl, hexyl, n-hexyl, n-heptyl, n-octyl, n-nonyl, n-decyl, isopropyl, 2-methylpropyl, cyclopropyl, cyclopropylmethyl, cyclobutyl, cyclopentyl, cyclopentylethyl, cyclohexyl, cyclohexylethyl and cyclohexyl, among others.

Numbering scheme for caprolactones described herein:

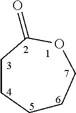

An aspect of the present disclosure provides a polymeric composition comprising, consists essentially of, or consists of a reaction product of: (a) one or more (e.g., 1, 2, 3, 4, or more) polycaprolactone co-polyol, wherein the one or more polycaprolactone co-polyol comprises, consists essentially of, or consists of a reaction product of one or more (e.g., 1, 2, 3, 4, or more) hydroxyl-functional organic compound with ε-caprolactone and one or more (e.g., 1, 2, 3, 4, 5, 6, 7, or more) ε-caprolactone with one alkyl substituent (e.g., a linear or branched C₁₋₁₀ alkyl), wherein (1) the one or more hydroxyl-functional organic compound is present in the range of about 5.0 wt % to about 95.0 wt %, (2) the ε-caprolactone is present in the range of about 5.0 wt % to about 95.0 wt % of the total molecular weight of the polycaprolactone co-polyol, (3) the one or more ε-caprolactone with one alkyl substituent is present in the range of about 5.0 wt % to about 95.0 wt % of the total molecular weight of the polycaprolactone co-polyol, and (4) the one or more polycaprolactone co-polyol is present in the range of about 5.0 wt % to 95.0 wt % of the polymeric composition and has an average molecular weight of about 500 g/mol to about 10,000 g/mol; (b) one or more (e.g., 1, 2, 3, 4, or more) diisocyanate that is present in the range of about 5.0 wt % to 95.0 wt % of the polymeric composition; and (c) optionally at least one of one or more (e.g., 1, 2, 3, 4, or more) diol chain extender, one or more (e.g., 1, 2, 3, 4, or more) diamine chain extender, or a combination thereof, having a molecular weight of about 60.0 g/mol to about 600.0 g/mol, with an NCO:OH molar ratio of from about 0.9:1 to about 2:1, wherein the one or more diol chain extender, the one or more diamine chain extender, or the combination thereof is present in the range of about 0.0 wt % to 25.0 wt % of the polymeric composition.

An aspect of the present disclosure provides a method of making a polymeric composition, the method comprising, consists essentially of, or consists of reacting: (a) one or more (e.g., 1, 2, 3, 4, or more) polycaprolactone co-polyol, wherein the one or more polycaprolactone co-polyol comprises, consists essentially of, or consists of a reaction product of one or more (e.g., 1, 2, 3, 4, or more) hydroxyl-functional organic compound with ε-caprolactone and one or more (e.g., 1, 2, 3, 4, 5, 6, 7, or more) ε-caprolactone with one alkyl substituent (e.g., a linear or branched C₁₋₁₀ alkyl), wherein (1) the one or more hydroxyl-functional organic compound is present in the range of about 5.0 wt % to about 95.0 wt %, (2) the ε-caprolactone is present in the range of about 5.0 wt % to about 95.0 wt % of the total molecular weight of the polycaprolactone co-polyol, (3) the one or more ε-caprolactone with one alkyl substituent is present in the range of about 5.0 wt % to about 95.0 wt % of the total molecular weight of the polycaprolactone co-polyol, and (4) the one or more polycaprolactone co-polyol is present in the range of about 5.0 wt % to 95.0 wt % of the polymeric composition and has an average molecular weight of about 500 g/mol to about 10,000 g/mol; (b) one or more (e.g., 1, 2, 3, 4, or more) diisocyanate that is present in the range of about 5.0 wt % to 95.0 wt % of the polymeric composition; and (c) optionally one or more (e.g., 1, 2, 3, 4, or more) diol chain extender, one or more (e.g., 1, 2, 3, 4, or more) diamine chain extender, or a combination thereof, having a molecular weight of about 60.0 g/mol to about 600.0 g/mol, with an NCO:OH molar ratio of from about 0.9:1 to about 2:1, wherein the one or more diol chain extender, the one or more diamine chain extender, or the combination thereof is present in the range of about 0.0 wt % to 25.0 wt % of the polymeric composition.

In an aspect or embodiment described herein, the reaction mixture further comprises, consists essentially of, or consisting of one or more (e.g., 1, 2, 3, or more) surfactant (e.g., one or more (e.g., 1, 2, 3, or more) silicone-based surfactant). In an aspect or embodiment described herein, the polymeric composition is a polyurethane foam (e.g., flexible polyurethane foam, slabstock polyurethane foam, moulded polyurethane foam, or microcellular polyurethane foam) and the reaction mixture further comprises, consists essentially of, or consisting of one or more (e.g., 1, 2, 3, or more) surfactant (e.g., one or more (e.g., 1, 2, 3, or more) silicone-based surfactant). In any aspect or embodiment described herein, the one or more surfactant comprises, consisting essentially of, or is at least one of polysiloxane polyoxyalkylene block copolymer, polyethersiloxane, or a mixture thereof. The method may further comprise, consist essentially of, or consist of, at least one of (1) agitating the reaction mixture or surfactant-containing reaction mixture (e.g., stirring at about 150 revolutions per minute (rpm) to about 600 rpm, about 200 rpm to about 500 rpm, or about 300 rpm to about 400 rpm) for up to about a 60 seconds (e.g., up to about 45 seconds, up to about 30 seconds, about 15 seconds to about 45 seconds, or about 20 seconds to about 40 seconds), (2) adding water to the reaction mixture or surfactant-containing reaction mixture and agitating the water-containing reaction mixture (e.g., stirring at about 150 revolutions per minute (rpm) to about 600 rpm, about 200 rpm to about 500 rpm, or about 300 rpm to about 400 rpm) for up to about 50 seconds (e.g., up to about 45 seconds, up to about 30 seconds, about 5 seconds to about 40 seconds, or about 10 seconds to about 30 seconds), (3) optionally further agitating (e.g., stirring at about 1500 revolutions per minute (rpm) to about 5000 rpm, about 2250 rpm to about 3750 rpm, or about 2750 rpm to about 3250 rpm) the water-containing reaction mixture for up to about 30 seconds (e.g., up to about 25 seconds, up to about 20 seconds, about 5 seconds to about 30 seconds, about 10 seconds to about 30 seconds, or about 15 seconds to about 25 seconds), or (4) a combination thereof. In any aspect or embodiment described herein, the agitated reaction mixture is immediately transferred to a mould (e.g., transferred to a mould to permit rising and/or completion of a foaming process), and optionally, cured (e.g., thermal post-curing in an oven, such as a convection oven, for about 30 minutes to about 150 minutes (e.g., 60 minutes to about 120 minutes, or about 75 minutes to about 105 minutes) at about 70° C. to about 130° C. (e.g., about 80° C. to about 120° C., about 90° C. to about 110° C., or about 95° C. to about 105° C.)).

In any aspect or embodiment described herein, at least one of (a) one or more polycaprolactone co-polyol is present in the range of about 40.0 wt % to about 70.0 wt % of the polymeric composition; (b) one or more diisocyanate is present in the range of about 30.0 wt % to about 60.0 wt % of the polymeric composition; (c) the one or more diol chain extender, the one or more diamine chain extender, or the combination thereof, is present in the range of about 0.0 wt % to about 15.0 wt % of the polymeric composition; or (d) a combination thereof.

In any aspect or embodiment described herein, at least one of (a) the one or more polycaprolactone co-polyol is present in the range of about 40.0 wt % to about 60.0 wt % of the polymeric composition; (b) the one or more diisocyanate is present in the range of about 40.0 wt % to about 60.0 wt % of the polymeric composition; (c) the one or more diol chain extender, the one or more diamine chain extender, or the combination thereof, is present in the range of about 0.0 wt % to about 15.0 wt % of the polymeric composition; or (d) a combination thereof.

In any aspect or embodiment described herein, the one or more (e.g., 1, 2, 3, 4, or more) polycaprolactone co-polyol is present in the range of about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, about 85.0 wt % to about 95.0 wt % of the total molecular weight of the polymeric composition.

In any aspect or embodiment described herein, the one or more (e.g., 1, 2, 3, 4, or more) diisocyanate is present in the range of about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, about 85.0 wt % to about 95.0 wt % of the total molecular weight of the polymeric composition.

In any aspect or embodiment described herein, the one or more diol chain extender, the one or more diamine chain extender, or the combination thereof, about 0.0 wt % to about 25.0 wt %, about 0.0 wt % to about 20.0 wt %, about 0.0 wt % to about 15.0 wt %, about 0.0 wt % to about 10.0 wt %, about 0.0 wt % to about 5.0 wt %, about 5.0 wt % to about 25.0 wt %, about 5.0 wt % to about 20.0 wt %, about 5.0 wt % to about 15.0 wt %, about 5.0 wt % to about 10.0 wt %, about 10.0 wt % to about 25.0 wt %, about 10.0 wt % to about 20.0 wt %, about 10.0 wt % to about 15.0 wt %, about 15.0 wt % to about 25.0 wt %, about 15.0 wt % to about 20.0 wt %, or about 20.0 wt % to about 25.0 wt % of the total molecular weight of the polymeric composition.

In any aspect or embodiment described herein, the one or more ε-caprolactone with one alkyl substituent comprises or is at least one of methylcaprolactone, ethylcaprolactone, propylcaprolactone, or a combination thereof.

In any aspect or embodiment described herein, the one or more ε-caprolactone with one alkyl substituent comprises or is at least one of 3-alkyl substituted caprolactone, 4-alkyl substituted caprolactone, 5-alkyl substituted caprolactone, 6-alkyl substituted caprolactone, 7-alkyl substituted caprolactone, or a combination thereof.

In any aspect or embodiment described herein, the one or more hydroxy-functional organic compound is present in the range of about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, about 85.0 wt % to about 95.0 wt % of the total molecular weight of the polycaprolactone co-polyol.

In any aspect or embodiment described herein, the ε-caprolactone is present in the range of about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, about 85.0 wt % to about 95.0 wt % of the total molecular weight of the polycaprolactone co-polyol.

In any aspect or embodiment described herein, the one or more ε-caprolactone with one alkyl substituent is present in the range of about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, about 85.0 wt % to about 95.0 wt % of the total molecular weight of the polycaprolactone co-polyol.

In any aspect or embodiment described herein, the one or more ε-caprolactone with one alkyl substituent is present in the range of about 5.0 wt % to about 50.0 wt % of the total molecular weight of the polycaprolactone co-polyol. For example, in any aspect or embodiment described herein, the one or more ε-caprolactone with one alkyl substituent is present in the range of about 5.0 wt % to about 35.0 wt % of the total molecular weight of the polycaprolactone co-polyol. By way of further example, in any aspect or embodiment described herein, the one or more ε-caprolactone with one alkyl substituent is present in the range of about 5.0 wt % to about 30.0 wt % of the total molecular weight of the polycaprolactone co-polyol. Additionally, in any aspect or embodiment described herein, the one or more ε-caprolactone with one alkyl substituent is present in the range of about 5.0 wt % to about 25.0 wt % or about 20.0 wt % of the total molecular weight of the polycaprolactone co-polyol.

In any aspect or embodiment described herein, the one or more hydroxyl-functional organic compound comprises or consists of at least one of (e.g., 1, 2, 3, or more) one or more (e.g., 1, 2, 3, or more) tertiary carbon atom (e.g., a carbon atom attached to three other carbon atoms), one or more (e.g., 1, 2, 3, or more) quaternary carbon atom (e.g., a carbon atom attached to four other carbon atoms), or a combination thereof.

In any aspect or embodiment described herein, the one or more hydroxyl-functional organic compound comprises or consists of at least one of one or more (e.g., 1, 2, 3, 4, or more) monol, one or more (e.g., 1, 2, 3, 4, or more) diol, one or more (e.g., 1, 2, 3, 4, or more) triol, one or more (e.g., 1, 2, 3, 4, or more) tetrol, or a combination thereof.

In any aspect or embodiment described herein, the one or more monol comprises or is one or more (e.g., 1, 2, 3, or more) linear or branched fatty alcohol (e.g., C₁₋₁₅, C₁₋₁₀, or C₁₋₅ fatty alcohol). For example, in any aspect or embodiment described herein, the one or more monol comprises or is at least one of methanol, ethanol, propanol (e.g., 1-propanol, 2-propanol, or a combination thereof), butanol (e.g., 1-butanol, 2-butanol, or a combination thereof), pentanol (e.g., 1-pentanol, 2-pentanol, 3-pentanol, or a combination thereof), hexanol (e.g., 1-hexanol, 2-hexanol, 3-hexanol, or a combination thereof), heptanol (e.g., 1-heptanol, 2-heptanol, 3-heptanol, 4-heptanol, or a combination thereof), octanol (e.g., 1-octanol, 2-octanol, 3-octanol, 4-octanol, or a combination thereof), nonanol (e.g., 1-nonanol, 2-nonanol, 3-nonanol, 4-nonanol, 5-nonanol, or a combination thereof), decanol (e.g., 1-decanol, 2-decanol, 3-decanol, 4-decanol, 5-decanol, or a combination thereof), or a combination thereof.

In any aspect or embodiment described herein, the one or more diol comprises or is one or more (e.g., 1, 2, 3, or more) linear or branched fatty alcohol (e.g., C₁₋₁₅, C₁₋₁₀, or C₁₋₅ fatty alcohol). For example, in any aspect or embodiment described herein, the one or more diol comprises or is at least one of methanediol, ethanediol (e.g., 1,1-ethanediol, 1,2-ethanediol, or a combination thereof), propanediol (e.g., 1,3-propanediol, 1,2-propane diol, 1,1-propanediol, 2,2-propanediol, or a combination thereof), butanediol (e.g., 1,4-butanediol, 1,3-butanediol, 1,2-butanediol, 2,3-butanediol, 1,1-butanediol, 2,2-butanediol, or a combination thereof), pentanediol (e.g., 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, or a mixture thereof), hexanediol (e.g., 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, or a mixture thereof), heptanediol (e.g., 1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2, 6-heptadiol, 3,3-heptadiol, 3,4-heptadiol, 1,1-heptadiol, 2,2-heptadiol, 3,3-heptadiol, 4,4-heptadiol, or a mixture thereof), octanediol (e.g., 1,8-octanediol), nonanediol (e.g., 1,9-nonanediol), decanediol (e.g., 1,10-decanediol), 3-methyl-1,5-pentanediol, neopentyl glycol, or a combination thereof. In any aspect or embodiment described herein, the one or more diol comprises or is one or more (e.g., 1, 2, 3, 4, or more) polyol comprising or consisting of at least one of poly(tetramethyleneglycol), poly(propylene glycol), poly(ethylene glycol), polycarbonate polyol, or a combination thereof.

In any aspect or embodiment described herein, the one or more triol comprises or is one or more (e.g., 1, 2, 3, or more) linear or branched fatty alcohol (e.g., C₁₋₁₅, C₁₋₁₀, or C₁₋₅ fatty alcohol). For example, in any aspect or embodiment described herein, the one or more triol comprises or is at least one of methanetriol, ethanetriol, propanetriol (e.g., glycerol), butanetriol, pentanetriol, hexanetriol, heptanetriol, octanetriol, nonanetriol, decanetriol, triethanolamine, trimethylolpropane, or a combination thereof.

In any aspect or embodiment described herein, the one or more tetrol comprises or is one or more (e.g., 1, 2, 3, or more) linear or branched fatty alcohol (e.g., C₁₋₁₅, C₁₋₁₀, or C₁₋₅ fatty alcohol). For example, in any aspect or embodiment described herein, the one or more tetrol comprises or is at least one of methanetetrol, ethanetetrol, propanetetrol, butanetetrol, pentanetetrol, hexanetetrol, heptanetetrol, octanetetrol, nonanetetrol, decanetetrol, pentaerythritol, or a combination thereof.

In any aspect or embodiment described herein, the one or more hydroxyl-functional organic compound comprises or is at least one of neopentyl glycol, trimethylolpropane, pentaerythritol, or a combination thereof (e.g., neopentyl glycol).

In any aspect or embodiment described herein, the polycaprolactone co-polyol has an average molecular weight of about 500 g/mol to about 10,000 g/mol, about 500 g/mol to about 9,000 g/mol, about 500 g/mol to about 8,000 g/mol, about 500 g/mol to about 7,000 g/mol, about 500 g/mol to about 6,000 g/mol, about 500 g/mol to about 5,000 g/mol, about 500 g/mol to about 4,000 g/mol, about 500 g/mol to about 3,000 g/mol, about 500 g/mol to about 2,000 g/mol, about 1,000 g/mol to about 10,000 g/mol, about 1,000 g/mol to about 9,000 g/mol, about 1,000 g/mol to about 8,000 g/mol, about 1,000 g/mol to about 7,000 g/mol, about 1,000 g/mol to about 6,000 g/mol, about 1,000 g/mol to about 5,000 g/mol, about 1,000 g/mol to about 4,000 g/mol, about 1,000 g/mol to about 3,000 g/mol, about 1,000 g/mol to about 2,000 g/mol, about 1,500 g/mol to about 10,000 g/mol, about 1,500 g/mol to about 9,000 g/mol, about 1,500 g/mol to about 8,000 g/mol, about 1,500 g/mol to about 7,000 g/mol, about 1,500 g/mol to about 6,000 g/mol, about 1,500 g/mol to about 5,000 g/mol, about 1,500 g/mol to about 4,000 g/mol, about 1,500 g/mol to about 3,000 g/mol, about 2,000 g/mol to about 10,000 g/mol, about 2,000 g/mol to about 9,000 g/mol, about 2,000 g/mol to about 8,000 g/mol, about 2,000 g/mol to about 7,000 g/mol, about 2,000 g/mol to about 6,000 g/mol, about 2,000 g/mol to about 5,000 g/mol, about 2,000 g/mol to about 4,000 g/mol, about 2,000 g/mol to about 3,000 g/mol, about 2,500 g/mol to about 10,000 g/mol, about 2,500 g/mol to about 9,000 g/mol, about 2,500 g/mol to about 8,000 g/mol, about 2,500 g/mol to about 7,000 g/mol, about 2,500 g/mol to about 6,000 g/mol, about 2,500 g/mol to about 5,000 g/mol, about 2,500 g/mol to about 4,000 g/mol, about 3,000 g/mol to about 10,000 g/mol, about 3,000 g/mol to about 9,000 g/mol, about 3,000 g/mol to about 8,000 g/mol, about 3,000 g/mol to about 7,000 g/mol, about 3,000 g/mol to about 6,000 g/mol, about 3,000 g/mol to about 5,000 g/mol, about 3,000 g/mol to about 4,000 g/mol, about 3,500 g/mol to about 10,000 g/mol, about 3,500 g/mol to about 9,000 g/mol, about 3,500 g/mol to about 8,000 g/mol, about 3,500 g/mol to about 7,000 g/mol, about 3,500 g/mol to about 6,000 g/mol, about 3,500 g/mol to about 5,000 g/mol, about 4,000 g/mol to about 10,000 g/mol, about 4,000 g/mol to about 9,000 g/mol, about 4,000 g/mol to about 8,000 g/mol, about 4,000 g/mol to about 7,000 g/mol, about 4,000 g/mol to about 6,000 g/mol, about 4,000 g/mol to about 5,000 g/mol, about 4,500 g/mol to about 10,000 g/mol, about 4,500 g/mol to about 9,000 g/mol, about 4,500 g/mol to about 8,000 g/mol, about 4,500 g/mol to about 7,000 g/mol, about 4,500 g/mol to about 6,000 g/mol, about 5,000 g/mol to about 10,000 g/mol, about 5,000 g/mol to about 9,000 g/mol, about 5,000 g/mol to about 8,000 g/mol, about 5,000 g/mol to about 7,000 g/mol, about 5,000 g/mol to about 6,000 g/mol, about 5,500 g/mol to about 10,000 g/mol, about 5,500 g/mol to about 9,000 g/mol, about 5,500 g/mol to about 8,000 g/mol, about 5,500 g/mol to about 7,000 g/mol, about 6,000 g/mol to about 10,000 g/mol, about 6,000 g/mol to about 9,000 g/mol, about 6,000 g/mol to about 8,000 g/mol, about 6,000 g/mol to about 7,000 g/mol, about 6,500 g/mol to about 10,000 g/mol, about 6,500 g/mol to about 9,000 g/mol, about 6,500 g/mol to about 8,000 g/mol, about 7,000 g/mol to about 10,000 g/mol, about 7,000 g/mol to about 9,000 g/mol, about 7,000 g/mol to about 8,000 g/mol, about 7,500 g/mol to about 10,000 g/mol, about 7,500 g/mol to about 9,000 g/mol, about 8,000 g/mol to about 10,000 g/mol, about 8,000 g/mol to about 9,000 g/mol, or about 8,500 g/mol to about 10,000 g/mol.

In any aspect or embodiment described herein, the one or more polycaprolactone co-polyol has an average molecular weight of about 500 g/mol to about 4000 g/mol. For example, in any aspect or embodiment described herein, the one or more polycaprolactone co-polyol has an average molecular weight of about 500 g/mol to about 2000 g/mol.

In any aspect or embodiment described herein, the one or more polycaprolactone co-polyol has an average molecular weight of about 1000 g/mol to about 4000 g/mol. For example, in any aspect or embodiment described herein, the one or more polycaprolactone co-polyol has an average molecular weight of about 1000 g/mol to about 2000 g/mol.

In any aspect or embodiment described herein, the one or more polycaprolactone co-polyol is a liquid at ambient temperature (e.g., about 15° C. to about 35° C.) and ambient pressure (e.g., about 0 to about 1 standard atmosphere (atm)). For example, in any aspect or embodiment described herein, the polycaprolactone co-polyol is a liquid at about 15° C. to about 35° C., about 15° C. to about 30° C., about 15° C. to about 25° C., about 15° C. to about 20° C., about 20° C. to about 35° C., about 20° C. to about 30° C., about 20° C. to about 25° C., about 25° C. to about 35° C., about 25° C. to about 30° C., or about 30° C. to about 35° C. By way of further example, in any aspect or embodiment described herein, the polycaprolactone co-polyol is a liquid at about 0.0 to about 1.0 atm, about 0.0 to about 0.8 atm, about 0.0 to about 0.6 atm, about 0.0 to about 0.4 atm, about 0.0 to about 0.2 atm, about 0.2 to about 1.0 atm, about 0.2 to about 0.8 atm, about 0.2 to about 0.6 atm, about 0.2 to about 0.4 atm, about 0.4 to about 1.0 atm, about 0.4 to about 0.8 atm, about 0.4 to about 0.6 atm, about 0.6 to about 1.0 atm, about 0.6 to about 0.8 atm, or about 0.8 to about 1.0 atm.

In any aspect or embodiment described herein, the one or more polycaprolactone co-polyol has a ¹⁴C/¹²C ratio equal to or greater than zero.

In any aspect or embodiment described herein, the one or more diisocyanate comprises or is at least one of diphenylmethane diisocyanate, carbodiimide-uretonimine modified diphenylmethane diisocyanate, 4,4′-diphenylmethane diisocyanate, carbodiimide-uretonimine modified 4,4′-diphenylmethane diisocyanate, 2,2′-diphenylmethane diisocyanate, carbodiimide-uretonimine modified 2,2′-diphenylmethane diisocyanate, 2,4′-diphenylmethane diisocyanate, carbodiimide-uretonimine modified 2,4′-diphenylmethane diisocyanate, isophorone diisocyanate, bimethylene diisocyanate, trimethylene diisocyanate (e.g., 1,3-trimethylene diisocyanate, 2,3-trimethylene diisocyanate, 1,2-trimethylene diisocyanate, 2,2-trimethylene diisocyanate, or a mixture thereof), tetramethylene diisocyanate (e.g., 1,4-tetramethylene diisocyanate, 1,3-tetramethylene diisocyanate, 1,2-tetramethylene diisocyanate, 2,3-tetramethylene diisocyanate, 1,1-tetramethylene diisocyanate, 2,2-tetramethylene diisocyanate, or a mixture thereof), pentamethylene diisocyanate (e.g., 1,5-pentamethylene diisocyanate, 1,4-pentamethylene diisocyanate, 1,3-pentamethylene diisocyanate, 1,2-pentamethylene diisocyanate, 2,3-pentamethylene diisocyanate, 2,4-pentamethylene diisocyanate, 3,4-pentamethylene diisocyanate, 3,5-pentamethylene diisocyanate, 1,1-pentamethylene diisocyanate, 2,2-pentamethylene diisocyanate, 3,3-pentamethylene diisocyanate, or a mixture thereof), hexamethylene diisocyanate (e.g., 1,6-hexamethylene diisocyanate, 1,5-hexamethylene diisocyanate, 1,4-hexamethylene diisocyanate, 1,3-hexamethylene diisocyanate, 1,2-hexamethylene diisocyanate, 2,3-hexamethylene diisocyanate, 2,4-hexamethylene diisocyanate, 2,5-hexamethylene diisocyanate, 3,4-hexamethylene diisocyanate, 3,5-hexamethylene diisocyanate, 4,5-hexamethylene diisocyanate, 1,1-hexamethylene diisocyanate, 2,2-hexamethylene diisocyanate, 3,3-hexamethylene diisocyanate, or a mixture thereof), heptamethylene diisocyanate (e.g., 1,7-heptamethylene diisocyanate, 1,6-heptamethylene diisocyanate, 1,5-heptamethylene diisocyanate, 1,4-heptamethylene diisocyanate, 1,3-heptamethylene diisocyanate, 1,2-heptamethylene diisocyanate, 2,3-heptamethylene diisocyanate, 2,4-heptamethylene diisocyanate, 2,5-heptamethylene diisocyanate, 2,6-heptamethylene diisocyanate, 3,3-heptamethylene diisocyanate, 3,4-heptamethylene diisocyanate, 1,1-heptamethylene diisocyanate, 2,2-heptamethylene diisocyanate, 3,3-heptamethylene diisocyanate, 4,4-heptamethylene diisocyanate, or a mixture thereof), toluene diisocyanate (e.g., toluene-2,4-diisocyanate, toluene-2,6-diisocyanate, or a mixture thereof), naphthylene diisocyanate (e.g., 1,2-naphthylene diisocyanate, 1,3-naphthylene diisocyanate, 1,4-naphthylene diisocyanate, 1,5-naphthylene diisocyanate, 1,6-naphthylene diisocyanate, 1,7-naphthylene diisocyanate, 1,8-naphthylene diisocyanate, or a mixture thereof), cyclohexylmethane diisocyanate (e.g., 1,4-cyclohexylmethane diisocyanate, 2,4-cyclohexylmethane diisocyanate, 3,4-cyclohexylmethane diisocyanate, 4,4-cyclohexylmethane diisocyanate, or a mixture thereof), dicyclohexylmethane diisocyanate (e.g., 4,4′-dicyclohexylmethane diisocyanate, 1,4-dicyclohexylmethane diisocyanate, or a mixture thereof), or a mixture thereof.

In any aspect or embodiment described herein, the one or more diisocyanate comprises or is at least one of diphenylmethane diisocyanate, carbodiimide-uretonimine modified diphenylmethane diisocyanate, 4,4′-diphenylmethane diisocyanate, carbodiimide-uretonimine modified 4,4′-diphenylmethane diisocyanate, 2,2′-diphenylmethane diisocyanate, carbodiimide-uretonimine modified 2,2′-diphenylmethane diisocyanate, 2,4′-diphenylmethane diisocyanate, carbodiimide-uretonimine modified 2,4′-diphenylmethane diisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof.

In any aspect or embodiment described herein, the one or more diol chain extender comprises or is an aliphatic diol or an aromatic diol.

In any aspect or embodiment described herein, the one or more diol chain extender comprises or is at least one of an alkylene oxide or glycol, ethylene glycol, propanediol (e.g., 1,3-propanediol, 1,2-propanediol, 1,1-propanediol, 2,2-propanediol, or a mixture thereof), butanediol (e.g., 1,4-butanediol, 1,3-butanediol, 1,2-butanediol, 2,3-butanediol, 1,1-butanediol, 2,2-butanediol, or a mixture thereof), pentadiol (e.g., 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, or a mixture thereof), hexanediol (e.g., 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, or a mixture thereof), heptadiol (e.g., 1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2, 6-heptadiol, 3,3-heptadiol, 3,4-heptadiol, 1,1-heptadiol, 2,2-heptadiol, 3,3-heptadiol, 4,4-heptadiol, or a mixture thereof), dihydroxybenzene (e.g., 1,2-dihydroxybenzene, 1,3-dihydroxybenzene, 1,4-dihydroxybenzene, or a mixture thereof), di(hydroxyethyl)-hydroxyquinone (e.g., 1,4-di-(betahydroxyethyl)-hydroxyquinone, 2,5-di-(hydroxyethyl)-hydroxyquinone, 2,3-di-(hydroxyethyl)-hydroxyquinone, 3,5-di-(hydroxyethyl)-hydroxyquinone, or mixtures thereof), di(hydroxymethyl)-hydroxyquinone (e.g., 2,5-di-(hydroxyethyl)-hydroxyquinone, 2,3-di-(hydroxymethyl)-hydroxyquinone, 3,5-di-(hydroxymethyl)-hydroxyquinone, or mixtures thereof), di-(hydroxyethyl)-bisphenol A (e.g., 1,4-di-(betahydroxyethyl)-bisphenol A, 1,3-di-(betahydroxyethyl)-bisphenol A, 1,2-di-(betahydroxyethyl)-bisphenol A, 1,5-di-(betahydroxyethyl)-bisphenol A, 2,3-di-(betahydroxyethyl)-bisphenol A, 2,4-di-(betahydroxyethyl)-bisphenol A, 2,5-di-(betahydroxyethyl)-bisphenol A, 2,6-di-(betahydroxyethyl)-bisphenol A, 3,4-di-(betahydroxyethyl)-bisphenol A, 3,5-di-(betahydroxyethyl)-bisphenol A, or a mixture thereof), or a mixture thereof.

In any aspect or embodiment described herein, the one or more diol chain extender comprises or is at least one of ethylene glycol, 1,4-butanediol, 1,6-hexanediol, 1,4-di-(betahydroxyethyl)-hydroxyquinone, 1,4-di-(betahydroxyethyl)-bisphenol A, or a mixture thereof.

In any aspect or embodiment described herein, the one or more diamine chain extender comprises or is at least one of diaminodiphenylmethane (e.g., 2,2′-diaminodiphenylmethane, 2,3′-diaminodiphenylmethane, 2,4′-diaminodiphenylmethane, 2,5′-diaminodiphenylmethane, 2,6′-diaminodiphenylmethane, 3,4′-diaminodiphenylmethane, 3,5′-diaminodiphenylmethane, 3,6′-diaminodiphenylmethane, 4,4′-diaminodiphenylmethane, 4,5′-diaminodiphenylmethane, 4,6′-diaminodiphenylmethane, 5,6′-diaminodiphenylmethane, or a mixture thereof), dichloro-diaminodiphenylmethane (e.g., 2,2′-dichloro-3,3′-diaminodiphenylmethane, 2,2′-dichloro-4,4′-diaminodiphenylmethane, 5,5′-dichloro-3,3′-diaminodiphenylmethane, 2,2′-dichloro-6,6′-diaminodiphenylmethane, 2,2′-dichloro-3,4′-diaminodiphenylmethane, 2,2′-dichloro-3,5′-diaminodiphenylmethane, 2,2′-dichloro-3,6′-diaminodiphenylmethane, 2,2′-dichloro-4,5′-diaminodiphenylmethane, 2,2′-dichloro-4,6′-diaminodiphenylmethane, 2,2′-dichloro-5,6′-diaminodiphenylmethane, 3,3′-dichloro-2,2′-diaminodiphenylmethane, 3,3′-dichloro-4,4′-diaminodiphenylmethane, 3,3′-dichloro-5,5′-diaminodiphenylmethane, 3,3′-dichloro-6,6′-diaminodiphenylmethane, 3,3′-dichloro-2,5′-diaminodiphenylmethane, 3,3′-dichloro-4,5′-diaminodiphenylmethane, 3,3′-dichloro-6,5′-diaminodiphenylmethane, 3,3′-dichloro-4,2′-diaminodiphenylmethane, 3,3′-dichloro-4,6′-diaminodiphenylmethane,4,4′-dichloro-2,2′-diaminodiphenylmethane, 4,4′-dichloro-3,3′-diaminodiphenylmethane, 4,4′-dichloro-5,5′-diaminodiphenylmethane, 4,4′-dichloro-6,6′-diaminodiphenylmethane, 4,4′-dichloro-2,3′-diaminodiphenylmethane, 4,4′-dichloro-2,5′-diaminodiphenylmethane, 4,4′-dichloro-2,6′-diaminodiphenylmethane, 4,4′-dichloro-3,5′-diaminodiphenylmethane, 4,4′-dichloro-3,6′-diaminodiphenylmethane, 4,4′-dichloro-5,6′-diaminodiphenylmethane, 5,5′-dichloro-2,2′-diaminodiphenylmethane, 5,5′-dichloro-3,3′-diaminodiphenylmethane, 5,5′-dichloro-4,4′-diaminodiphenylmethane, 5,5′-dichloro-6,6′-diaminodiphenylmethane, 5,5′-dichloro-2,3′-diaminodiphenylmethane, 5,5′-dichloro-2,4′-diaminodiphenylmethane, 5,5′-dichloro-2,6′-diaminodiphenylmethane, 5,5′-dichloro-3,4′-diaminodiphenylmethane, 5,5′-dichloro-3,6′-diaminodiphenylmethane, 5,5′-dichloro-4,6′-diaminodiphenylmethane, 6,6′-dichloro-2,2′-diaminodiphenylmethane, 6,6′-dichloro-3,3′-diaminodiphenylmethane, 6,6′-dichloro-4,4′-diaminodiphenylmethane, 6,6′-dichloro-5,5′-diaminodiphenylmethane, 6,6′-dichloro-2,3′-diaminodiphenylmethane, 6,6′-dichloro-2,4′-diaminodiphenylmethane, 6,6′-dichloro-2,5′-diaminodiphenylmethane, 6,6′-dichloro-3,4′-diaminodiphenylmethane, 6,6′-dichloro-3,5′-diaminodiphenylmethane, 6,6′-dichloro-4,5′-diaminodiphenylmethane, or a mixture thereof), diaminobenzene (e.g., 1,4-diaminobenzene, 1,2-diaminobenzene, 1,3-diaminobenzene, or a mixture thereof), dimethoxy-diamino biphenyl (e.g., 2,2′-dimethoxy-3,3′-diamino biphenyl, 2,2′-dimethoxy-4,4′-diamino biphenyl, 5,5′-dimethoxy-3,3′-diamino biphenyl, 2,2′-dimethoxy-6,6′-diamino biphenyl, 2,2′-dimethoxy-3,4′-diamino biphenyl, 2,2′-dimethoxy-3,5′-diamino biphenyl, 2,2′-dimethoxy-3,6′-diamino biphenyl, 2,2′-dimethoxy-4,5′-diamino biphenyl, 2,2′-dimethoxy-4,6′-diamino biphenyl, 2,2′-dimethoxy-5,6′-diamino biphenyl, 3,3′-dimethoxy-2,2′-diamino biphenyl, 3,3′-dimethoxy-4,4-diamino biphenyl, 3,3′-dimethoxy-5,5′-diamino biphenyl, 3,3′-dimethoxy-6,6′-diamino biphenyl, 3,3′-dimethoxy-2,5′-diamino biphenyl, 3,3′-dimethoxy-4,5′-diamino biphenyl, 3,3′-dimethoxy-6,5′-diamino biphenyl, 3,3′-dimethoxy-4,2′-diamino biphenyl, 3,3′-dimethoxy-4,6′-diamino biphenyl,4,4′-dimethoxy-2,2′-diamino biphenyl, 4,4′-dimethoxy-3,3′-diamino biphenyl, 4,4′-dimethoxy-5,5′-diamino biphenyl, 4,4′-dimethoxy-6,6′-diamino biphenyl, 4,4′-dimethoxy-2,3′-diamino biphenyl, 4,4′-dimethoxy-2,5′-diamino biphenyl, 4,4′-dimethoxy-2,6′-diamino biphenyl, 4,4′-dimethoxy-3,5′-diamino biphenyl, 4,4′-dimethoxy-3,6′-diamino biphenyl, 4,4′-dimethoxy-5,6′-diamino biphenyl, 5,5′-dimethoxy-2,2′-diamino biphenyl, 5,5′-dimethoxy-3,3′-diamino biphenyl, 5,5′-dimethoxy-4,4′-diamino biphenyl, 5,5′-dimethoxy-6,6′-diamino biphenyl, 5,5′-dimethoxy-2,3′-diamino biphenyl, 5,5′-dimethoxy-2,4′-diamino biphenyl, 5,5′-dimethoxy-2,6′-diamino biphenyl, 5,5′-dimethoxy-3,4′-diamino biphenyl, 5,5′-dimethoxy-3,6′-diamino biphenyl, 5,5′-dimethoxy-4,6′-diamino biphenyl, 6,6′-dimethoxy-2,2′-diamino biphenyl, 6,6′-dimethoxy-3,3′-diamino biphenyl, 6,6′-dimethoxy-4,4′-diamino biphenyl, 6,6′-dimethoxy-5,5′-diamino biphenyl, 6,6′-dimethoxy-2,3′-diamino biphenyl, 6,6′-dimethoxy-2,4′-diamino biphenyl, 6,6′-dimethoxy-2,5′-diamino biphenyl, 6,6′-dimethoxy-3,4′-diamino biphenyl, 6,6′-dimethoxy-3,5′-diamino biphenyl, 6,6′-dimethoxy-4,5′-diamino biphenyl, or a mixture thereof), dimethyl-diamino biphenyl (e.g., 2,2′-dimethyl-3,3′-diamino biphenyl, 2,2′-dimethyl-4,4′-diamino biphenyl, 5,5′-dimethyl-3,3′-diamino biphenyl, 2,2′-dimethyl-6,6′-diamino biphenyl, 2,2′-dimethyl-3,4′-diamino biphenyl, 2,2′-dimethyl-3,5′-diamino biphenyl, 2,2′-dimethyl-3,6′-diamino biphenyl, 2,2′-dimethyl-4,5′-diamino biphenyl, 2,2′-dimethyl-4,6′-diamino biphenyl, 2,2′-dimethyl-5,6′-diamino biphenyl, 3,3′-dimethyl-2,2′-diamino biphenyl, 3,3′-dimethyl-4,4-diamino biphenyl, 3,3′-dimethyl-5,5′-diamino biphenyl, 3,3′-dimethyl-6,6′-diamino biphenyl, 3,3′-dimethyl-2,5′-diamino biphenyl, 3,3′-dimethyl-4,5′-diamino biphenyl, 3,3′-dimethyl-6,5′-diamino biphenyl, 3,3′-dimethyl-4,2′-diamino biphenyl, 3,3′-dimethyl-4,6′-diamino biphenyl,4,4′-dimethyl-2,2′-diamino biphenyl, 4,4′-dimethyl-3,3′-diamino biphenyl, 4,4′-dimethyl-5,5′-diamino biphenyl, 4,4′-dimethyl-6,6′-diamino biphenyl, 4,4′-dimethyl-2,3′-diamino biphenyl, 4,4′-dimethyl-2,5′-diamino biphenyl, 4,4′-dimethyl-2,6′-diamino biphenyl, 4,4′-dimethyl-3,5′-diamino biphenyl, 4,4′-dimethyl-3,6′-diamino biphenyl, 4,4′-dimethyl-5,6′-diamino biphenyl, 5,5′-dimethyl-2,2′-diamino biphenyl, 5,5′-dimethyl-3,3′-diamino biphenyl, 5,5′-dimethyl-4,4′-diamino biphenyl, 5,5′-dimethyl-6,6′-diamino biphenyl, 5,5′-dimethyl-2,3′-diamino biphenyl, 5,5′-dimethyl-2,4′-diamino biphenyl, 5,5′-dimethyl-2,6′-diamino biphenyl, 5,5′-dimethyl-3,4′-diamino biphenyl, 5,5′-dimethyl-3,6′-diamino biphenyl, 5,5′-dimethyl-4,6′-diamino biphenyl, 6,6′-dimethyl-2,2′-diamino biphenyl, 6,6′-dimethyl-3,3′-diamino biphenyl, 6,6′-dimethyl-4,4′-diamino biphenyl, 6,6′-dimethyl-5,5′-diamino biphenyl, 6,6′-dimethyl-2,3′-diamino biphenyl, 6,6′-dimethyl-2,4′-diamino biphenyl, 6,6′-dimethyl-2,5′-diamino biphenyl, 6,6′-dimethyl-3,4′-diamino biphenyl, 6,6′-dimethyl-3,5′-diamino biphenyl, 6,6′-dimethyl-4,5′-diamino biphenyl, or a mixture thereof), diamino biphenyl (e.g., 2,2′-diamino biphenyl, 2,3′-diamino biphenyl, 2,4′-diamino biphenyl, 2,5′-diamino biphenyl, 2,6′-diamino biphenyl, 3,4′-diamino biphenyl, 3,5′-diamino biphenyl, 3,6′-diamino biphenyl, 4,4′-diamino biphenyl, 4,5′-diamino biphenyl, 4,6′-diamino biphenyl, 5,6′-diamino biphenyl, or a mixture thereof), dichloro-diamino biphenyl (e.g., 2,2′-dichloro-3,3′-diamino biphenyl, 2,2′-dichloro-4,4′-diamino biphenyl, 5,5′-dichloro-3,3′-diamino biphenyl, 2,2′-dichloro-6,6′-diamino biphenyl, 2,2′-dichloro-3,4′-diamino biphenyl, 2,2′-dichloro-3,5′-diamino biphenyl, 2,2′-dichloro-3,6′-diamino biphenyl, 2,2′-dichloro-4,5′-diamino biphenyl, 2,2′-dichloro-4,6′-diamino biphenyl, 2,2′-dichloro-5,6′-diamino biphenyl, 3,3′-dichloro-2,2′-diamino biphenyl, 3,3′-dichloro-4,4′-diamino biphenyl, 3,3′-dichloro-5,5′-diamino biphenyl, 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl,4,4′-dichloro-2,2′-diamino biphenyl, 4,4′-dichloro-3,3′-diamino biphenyl, 4,4′-dichloro-5,5′-diamino biphenyl, 4,4′-dichloro-6,6′-diamino biphenyl, 4,4′-dichloro-2,3′-diamino biphenyl, 4,4′-dichloro-2,5′-diamino biphenyl, 4,4′-dichloro-2,6′-diamino biphenyl, 4,4′-dichloro-3,5′-diamino biphenyl, 4,4′-dichloro-3,6′-diamino biphenyl, 4,4′-dichloro-5,6′-diamino biphenyl, 5,5′-dichloro-2,2′-diamino biphenyl, 5,5′-dichloro-3,3′-diamino biphenyl, 5,5′-dichloro-4,4′-diamino biphenyl, 5,5′-dichloro-6,6′-diamino biphenyl, 5,5′-dichloro-2,3′-diamino biphenyl, 5,5′-dichloro-2,4′-diamino biphenyl, 5,5′-dichloro-2,6′-diamino biphenyl, 5,5′-dichloro-3,4′-diamino biphenyl, 5,5′-dichloro-3,6′-diamino biphenyl, 5,5′-dichloro-4,6′-diamino biphenyl, 6,6′-dichloro-2,2′-diamino biphenyl, 6,6′-dichloro-3,3′-diamino biphenyl, 6,6′-dichloro-4,4′-diamino biphenyl, 6,6′-dichloro-5,5′-diamino biphenyl, 6,6′-dichloro-2,3′-diamino biphenyl, 6,6′-dichloro-2,4′-diamino biphenyl, 6,6′-dichloro-2,5′-diamino biphenyl, 6,6′-dichloro-3,4′-diamino biphenyl, 6,6′-dichloro-3,5′-diamino biphenyl, 6,6′-dichloro-4,5′-diamino biphenyl, or a mixture thereof), or a mixture thereof.

In any aspect or embodiment described herein, the one or more diamine chain extender comprises or is at least one of 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl, or a mixtures thereof.

In any aspect or embodiment described herein, the polymeric composition is a polyurethane elastomer, a thermoplastic polyurethane, a hot cast polyurethane elastomer, a cold cast elastomer, a polyurethane foam, a flexible polyurethane foam, a slabstock polyurethane foam, a moulded polyurethane foam, a microcellular polyurethane foam, a polyurethane dispersion in aqueous or organic media, a polyurethane adhesive, a one-component polyurethane coating, a two-component polyurethane coating, an additive manufacturing composition/resin, or a polyurethane sealant.

In any aspect or embodiment described herein, the polymeric composition is a polyurethane elastomer (e.g., a thermoplastic polyurethane, a hot cast elastomer, or a cold cast elastomer).

Another aspect of the present disclosure provides a polyurethane elastomer, a thermoplastic polyurethane, a hot cast elastomer, a cold cast elastomer, a polyurethane foam, a flexible polyurethane foam, a slabstock polyurethane foam, a moulded polyurethane foam, a microcellular polyurethane foam, a polyurethane dispersion in aqueous or organic media, a polyurethane adhesive, a one-component polyurethane coating, a two-component polyurethane coating, an additive manufacturing composition/resin, or a polyurethane sealant, comprising or consisting essentially of the polymeric composition of the present disclosure.

A further aspect of the present disclosure provides a polyurethane elastomer, a thermoplastic polyurethane, a hot cast elastomer, a cold cast elastomer, a polyurethane foam, a flexible polyurethane foam, a slabstock polyurethane foam, a moulded polyurethane foam, a microcellular polyurethane foam, a polyurethane dispersion in aqueous or organic media, a polyurethane adhesive, a 1-component polyurethane coating, a 2-component polyurethane coating, an additive manufacturing composition/resin, or a polyurethane sealant, comprising or consisting essentially of the polymeric composition of the present disclosure, wherein the one or more polycaprolactone co-polyol has an average molecular weight of about 800 g/mol to about 10,000 g/mol (e.g., about 800 g/mol to about 10,000 g/mol).

In any aspect or embodiment described herein, the polymeric composition is present in an amount of about 5.0 wt % to about 100.0 wt % of the polyurethane elastomer, the thermoplastic polyurethane, the hot cast elastomer, the cold cast elastomer, the polyurethane foam, the flexible polyurethane foam, the slabstock polyurethane foam, the moulded polyurethane foam, the microcellular polyurethane foam, the polyurethane dispersion in aqueous or organic media, the polyurethane adhesive, the one-component polyurethane coating, the two-component polyurethane coating, the additive manufacturing composition/resin, or the polyurethane sealant. For example, in any aspect or embodiment described herein, the polymeric composition is present in an amount of about 5.0 wt % to about 100.0 wt %, about 10.0 wt % to about 100.0 wt %, about 15.0 wt % to about 100.0 wt %, about 20.0 wt % to about 100.0 wt %, about 25.0 wt % to about 100.0 wt %, about 30.0 wt % to about 100.0 wt %, about 35.0 wt % to about 100.0 wt %, about 40.0 wt % to about 100.0 wt %, about 45.0 wt % to about 100.0 wt %, about 50.0 wt % to about 100.0 wt %, about 55.0 wt % to about 100.0 wt %, about 60.0 wt % to about 100.0 wt %, about 65.0 wt % to about 100.0 wt %, about 70.0 wt % to about 100.0 wt %, about 75.0 wt % to about 100.0 wt %, about 80.0 wt % to about 100.0 wt %, about 85.0 wt % to about 100.0 wt %, about 90.0 wt % to about 100.0 wt %, about 5.0 wt % to about 95.0 wt %, about 5.0 wt % to about 90.0 wt %, about 5.0 wt % to about 85.0 wt %, about 5.0 wt % to about 80.0 wt %, about 5.0 wt % to about 75.0 wt %, about 5.0 wt % to about 70.0 wt %, about 5.0 wt % to about 65.0 wt %, about 5.0 wt % to about 60.0 wt %, about 5.0 wt % to about 55.0 wt %, about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 10.0 wt % to about 95.0 wt %, about 10.0 wt % to about 90.0 wt %, about 10.0 wt % to about 85.0 wt %, about 10.0 wt % to about 80.0 wt %, about 10.0 wt % to about 75.0 wt %, about 10.0 wt % to about 70.0 wt %, about 10.0 wt % to about 65.0 wt %, about 10.0 wt % to about 60.0 wt %, about 10.0 wt % to about 55.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 15.0 wt % to about 95.0 wt %, about 15.0 wt % to about 90.0 wt %, about 15.0 wt % to about 85.0 wt %, about 15.0 wt % to about 80.0 wt %, about 15.0 wt % to about 75.0 wt %, about 15.0 wt % to about 70.0 wt %, about 15.0 wt % to about 65.0 wt %, about 15.0 wt % to about 60.0 wt %, about 15.0 wt % to about 55.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 20.0 wt % to about 95.0 wt %, about 20.0 wt % to about 90.0 wt %, about 20.0 wt % to about 85.0 wt %, about 20.0 wt % to about 80.0 wt %, about 20.0 wt % to about 75.0 wt %, about 20.0 wt % to about 70.0 wt %, about 20.0 wt % to about 65.0 wt %, about 20.0 wt % to about 60.0 wt %, about 20.0 wt % to about 55.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 25.0 wt % to about 95.0 wt %, about 25.0 wt % to about 90.0 wt %, about 25.0 wt % to about 85.0 wt %, about 25.0 wt % to about 80.0 wt %, about 25.0 wt % to about 75.0 wt %, about 25.0 wt % to about 70.0 wt %, about 25.0 wt % to about 65.0 wt %, about 25.0 wt % to about 60.0 wt %, about 25.0 wt % to about 55.0 wt %, about 25.0 wt % to about 50.0 wt %, about 25.0 wt % to about 45.0 wt %, about 25.0 wt % to about 40.0 wt %, about 25.0 wt % to about 35.0 wt %, about 30.0 wt % to about 95.0 wt %, about 30.0 wt % to about 90.0 wt %, about 30.0 wt % to about 85.0 wt %, about 30.0 wt % to about 80.0 wt %, about 30.0 wt % to about 75.0 wt %, about 30.0 wt % to about 70.0 wt %, about 30.0 wt % to about 65.0 wt %, about 30.0 wt % to about 60.0 wt %, about 30.0 wt % to about 55.0 wt %, about 30.0 wt % to about 50.0 wt %, about 30.0 wt % to about 45.0 wt %, about 30.0 wt % to about 40.0 wt %, about 35.0 wt % to about 95.0 wt %, about 35.0 wt % to about 90.0 wt %, about 35.0 wt % to about 85.0 wt %, about 35.0 wt % to about 80.0 wt %, about 35.0 wt % to about 75.0 wt %, about 35.0 wt % to about 70.0 wt %, about 35.0 wt % to about 65.0 wt %, about 35.0 wt % to about 60.0 wt %, about 35.0 wt % to about 55.0 wt %, about 35.0 wt % to about 50.0 wt %, about 35.0 wt % to about 45.0 wt %, about 40.0 wt % to about 95.0 wt %, about 40.0 wt % to about 90.0 wt %, about 40.0 wt % to about 85.0 wt %, about 40.0 wt % to about 80.0 wt %, about 40.0 wt % to about 75.0 wt %, about 40.0 wt % to about 70.0 wt %, about 40.0 wt % to about 65.0 wt %, about 40.0 wt % to about 60.0 wt %, about 40.0 wt % to about 55.0 wt %, about 40.0 wt % to about 50.0 wt %, about 45.0 wt % to about 95.0 wt %, about 45.0 wt % to about 90.0 wt %, about 45.0 wt % to about 85.0 wt %, about 45.0 wt % to about 80.0 wt %, about 45.0 wt % to about 75.0 wt %, about 45.0 wt % to about 70.0 wt %, about 45.0 wt % to about 65.0 wt %, about 45.0 wt % to about 60.0 wt %, about 45.0 wt % to about 55.0 wt %, about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 70.0 wt % to about 95.0 wt %, about 70.0 wt % to about 90.0 wt %, about 70.0 wt % to about 85.0 wt %, about 70.0 wt % to about 80.0 wt %, about 75.0 wt % to about 95.0 wt %, about 75.0 wt % to about 90.0 wt %, about 75.0 wt % to about 85.0 wt %, about 80.0 wt % to about 95.0 wt %, about 80.0 wt % to about 90.0 wt %, or about 85.0 wt % to about 95.0 wt % of the polyurethane elastomer, the thermoplastic polyurethane, the hot cast elastomer, the cold cast elastomer, the polyurethane foam, the flexible polyurethane foam, the slabstock polyurethane foam, the moulded polyurethane foam, the microcellular polyurethane foam, the polyurethane dispersion in aqueous or organic media, the polyurethane adhesive, the one-component polyurethane coating, the two-component polyurethane coating, the additive manufacturing composition/resin, or the polyurethane sealant.

### EXAMPLES

Polyurethane elastomer articles from exemplary polyols of the present disclosure and comparative examples were produced by combining Polyols 1-4 and 1,4-butanediol chain extender, with carbodiimide-uretonimine modified methylene diphenyl diisocyanate (MDI; functionality=2.2) in the presence of tin catalyst, according to 97% stoichiometry or 103 isocyanate index, as per the formulations in Table 2. The composition of Polyols 1-3 are given in Table 1. Polyol 4 is a 2000 g/mol polyester diol based on diethylene glycol and adipic acid and is provided for comparative purposes. Components were homogenised using a high-speed mixer for 30 seconds at 2000 revolutions per minute (rpm) and poured on to a coated metal plate at 23° C. The cast sheets were held at 23° C./50% relative humidity (RH) for 16 hours before being demoulded.

TABLE 1
Exemplary Polycaprolactone Polyols

| | Polyol Number | | |
|---|---|---|---|
| | 1 | 2* | 3* |
| Hydroxyl Functional Initiator | Neopentyl | Neopentyl | Neopentyl |
| | glycol | glycol | glycol |
| Substituted ε-Caprolactone | 4-methyl- | | |
| | caprolactone | | |
| Polyol Molecular Weight (g/mol) | 2000 | 2000 | 900 |
| Hydroxyl Functional Initiator | 10 | 10 | 20 |
| (wt %) | | | |
| Substituted ε-Caprolactone (wt %) | 27 | — | — |
| ε-Caprolactone (wt %) | 63 | 90 | 80 |
| Viscosity at 23° C. (mPa · s) | 3795 | NA | 1250 |

| | | | | | | |
|---|---|---|---|---|---|---|
| [symbol] | [symbol] | [symbol] | [symbol] | [symbol] | [symbol] | [symbol] |
| [symbol] | [symbol] | [symbol] | [symbol] | [symbol] | [symbol] | [symbol] |
| [symbol] | [symbol] | — | [symbol] | [symbol] | [symbol] | [symbol] |
| [symbol] | [symbol] | — | [symbol] | [symbol] | [symbol] | [symbol] |

*Comparative example [symbol]
indicates data missing or illegible when filed

TABLE 2
Exemplary Polyurethanes

| | Polyol 1 | Polyol 2 | Polyol 3 | Polyol 4 | Chain Extender | Isocyanate |
|---|---|---|---|---|---|---|
| Ex. | (pphp) | (pphp) | (pphp) | (pphp) | (pphp) | (pphp) |
| 1 | 100 | | | | 13 | 60 |
| 2* | | 100 | | | 13 | 60 |
| 3* | | | 100 | | 3 | 58 |
| 4* | | | | 100 | 13 | 60 |

*Comparative example
pphp: parts per hundred polyol

Polyurethane elastomer articles were produced for comparison purposes (Table 3) by adding comparative Polyol 2 (heated to 60° C. to be in liquid form) dropwise to carbodiimide-uretonimine modified methylene diphenyl diisocyanate (MDI; functionality=2.2) and reacting at 80° C. for 1.5 hours (a traditional hot-casting process). To this, 1,4-butanediol was added, according to 97% stoichiometry or 103 isocyanate index, and the mixture homogenized using a vortex mixer for 2 minutes. The reaction mixture was then poured onto a coated metal plate that had been conditioned at 120° C. for 1 hour. The cast sheets were then placed in an oven at 120° C. for 16 hours before being demoulded and cooled to 23° C.

TABLE 3
Exemplary Polyurethanes

| | Polyol 2 | Chain Extender | Isocyanate |
|---|---|---|---|
| Ex. | (pphp) | (pphp)_{—} | (pphp) |
| 5* | 100 | 13 | 60 |

*Comparative example
pphp: parts per hundred polyol

Polyurethane flexible foam articles from examples of the present disclosure were produced according to the recipe in Table 5, using polyols given in Table 4 and other examples for comparison. The composition of Polyol 5 and Polyol 6 are provided in Table 4. Polyol 7 is a 2200-2800 g/mol polyester polyol (functionality 2.2-2.8) based on trimethylolpropane, adipic acid and diethylene glycol and is provided for comparative purposes, as a typical liquid polyester used in flexible foam recipes. Formulations were optimised to produce foams of the desired density (40-45 kg/m³) without collapse/shrinkage.

The method for preparing a polyurethane foam comprised introducing the predetermined quantities of polyol, surfactants, and catalyst into a suitable mixing vessel, followed by mechanical agitation using an overhead stirrer at approximately 350 rpm for 30 seconds to ensure homogeneity. A measured amount of water is then added to the mixture, which is further agitated at 350 rpm for an additional 20 seconds. Subsequently, the isocyanate component is incorporated into the formulation, and the resulting mixture is agitated at approximately 3000 rpm for 8 seconds to initiate the foaming reaction. The reactive mixture is immediately transferred into a mould comprising a 6×6×6 inch cardboard box lined with polypropylene film, where it is allowed to rise and complete the foaming process under ambient conditions. Upon completion of foaming, the formed foam is demoulded and subjected to thermal post-curing in a convection oven at 100° C. for 90 minutes, followed by conditioning at room temperature (approximately 20-25° C.) for a minimum 24 hours prior to testing.

TABLE 4
Exemplary Polycaprolactone Polyols

Polyol Number

| | 5 | 6* |
|---|---|---|
| Hydroxyl Functional Initiator | Trimethyl- | Trimethyl- |
| | olpropane | olpropane |
| Substituted ε-Caprolactone | 4-methyl- | |
| | caprolactone | |
| Polyol Molecular Weight (g/mol) | 3000 | 3000 |
| Hydroxyl Functional Initiator (wt %) | 3 | 3 |
| Substituted ε-Caprolactone (wt %) | 29 | |
| ε-Caprolactone (wt %) | 68 | 97 |
| Viscosity at 23° C. (mPa · s) | 5854 | NA |

*Comparative example
NA = Not Applicable

TABLE 5
Exemplary Polyurethanes Flexible Foam

Example Number

| | 7 | 8* | 9* |
|---|---|---|---|
| Polyol 5 (pphp) | 100 | | |
| Polyol 6 (pphp) | | 100 | |
| Polyol 7 (pphp) | | | 100 |
| Water (pphp) | 3.5 | 3.5 | 3.5 |
| TEGOSTAB ® B 8300 (pphp) | 0.9 | 0.9 | 1.5 |
| TEGOSTAB ® BF 2370 (pphp) | 0.6 | 0.6 | 0.0 |
| N-Ethylmorpholine (pphp) | 1.6 | 1.6 | 1.5 |
| TDI (80:20) (pphp) | 43 | 43 | 43 |

Comparative example
pphp: parts per hundred polyol,
NA = Not Applicable

The hardness of the polyurethane materials was determined in accordance with American Society for Testing and Materials (ASTM) D2240-15(2021) (Standard Test Method for Rubber Property—Durometer Hardness) after 1 day. Hardness is evaluated using a Shore A analogue durometer. 6.0 mm polyurethane sheets were conditioned at 23° C./50% RH for a period of 1 day prior to testing. To determine hardness, the analogue Shore A durometer is held vertically above a sheet of polyurethane elastomer with the indenter tip above the surface of the sample. The durometer is lowered down, and pressure applied to the durometer foot so that the indenter is pressed into the sample. A reading is taken after a dwell time of 15 s to give the Shore A hardness. This is repeated on four other areas of the specimen, and an average value taken.

The mechanical properties of the polyurethane material were determined according to International Organization for Standardization (ISO) 37:2017(E) (Rubber, vulcanized or thermoplastic—Determination of tensile stress-strain properties). Tensile tests were conducted according to ISO 37 using Type 2 specimens (dumbbell-shaped test pieces of 2.0 millimeter (mm) +/−0.2 mm in thickness and a test length of 20 mm +/−0.5 mm) in order to determine elongation at break. Test pieces were cut from 2.0 mm polyurethane sheets using a die-cutter and then conditioned at 23° C./50% RH for a period of 7 days prior to testing. Test pieces were subjected to deformation in tensile mode at a rate of traverse of 200 mm/min using a ProLine Z010 tensometer (ZwickRoell; Ulm, Germany) equipped with pincer grips and a 10 kilonewton (kN) load cell until the test piece is broken. Ultimate tensile strength is defined as the stress recorded at breakage of the sample, in megapascals (MPa or N/mm²). 100%, 200% and 300% modulus is defined as the stress recorded at the said elongation, in megapascals (MPa or N/mm²). Ultimate elongation is defined as the percentage increase in test length at break. The elastic modulus is defined as the average stress/strain in the first 0.25% elongation of the material and is a measure of the material's resistance to deformation.

Hydrolytic stability was determined using an in-house method whereby polyurethane samples were placed in an oven at 85° C./85% relative humidity for a period of 3 weeks. Following submersion, test pieces were dried and conditioned at 23° C./50% relative humidity (RH) for one day prior to tensile testing. Tensile tests were carried out in the same manner as that described to determine mechanical properties.

Compression set was measured using SATRA STD 401 apparatus. Three test pieces conforming to International Organization for Standardization (ISO) 815-1:2019, type B, were subjected to testing (constant deflection to 75%) at 70° C./50% relative humidity for 22 hours (dry) and 50° C./85% relative humidity (wet), and the average compression set calculated.

TABLE 6
Characteristics of Exemplary Polyurethanes Elastomers

| | Example Number | | | | |
|---|---|---|---|---|---|
| | 1 | 2* | 3* | 4* | 5* |
| Polyol | 1 | 2 | 3 | 4 | 2 |
| Hardness (Shore A) | 85 | NA | 91 | 81 | 80 |
| Elastic Modulus (MPa) | 56 | NA | 239 | 40 | ND |
| 100% Modulus (MPa) | 8.5 | NA | 19.8 | 8.2 | 6.1 |
| 200% Modulus (MPa) | 11.1 | NA | — | 11.5 | 10.8 |
| 300% Modulus (MPa) | 15.2 | NA | — | — | 30.5 |
| Ultimate Tensile Strength (MPa) | 18.1 | NA | 24.0 | 13.1 | 35.1 |
| Ultimate Elongation (%) | 350 | NA | 111 | 260 | 312 |
| Tg (DSC) (° C.) | −40 | NA | 21 | −26 | −26 |
| Tg (DMA) (° C.) | −25 | NA | 30 | −13 | NA |
| Mechanical Strength After 3 | 3.6 | NA | NA | 0 | — |
| weeks at 85° C./85% RH (MPa) | | | | | |

*Comparative example
ND = Not Determined,
NA = Not Applicable

Polyurethane elastomers were successfully prepared at room temperature (23° C.) using Polyol 1 of the present disclosure as the polyol exists in liquid form at this temperature. It was not possible to produce an elastomer at ambient temperature using Polyol 2 (comparative example) since it exists as a solid at this temperature and could not be poured into the reaction mixture.

Polyol 3 (comparative example) is an example of the highest molecular weight polycaprolactone polyol which remains liquid at ambient temperature and is commercially available. Due to the lower molecular weight compared to Polyol 1, coupled with its higher functionality, elastomers with higher stiffness (as shown by greater tensile modulus and 100% modulus) and with less resilience at room temperature (indicted by a high Tg) are produced. This demonstrates why novel polyols of the present disclosure are inventive and desirable.

Polyol 4 (comparative example), the highest molecular weight linear polyester diol which is known to be commercially available, can be used to produce elastomers at ambient temperature, but as is known with conventional polyesters, mechanical properties are not retained to any degree in humid environmental conditions, which is valuable in many outdoor or industrial applications. The inventions of the present disclosure also offer considerable value at low temperature due to the much lower Tg.

Whilst comparable performance to an elastomer produced in a hot cast process (where polyols are heated prior to casting) is not anticipated, Example 5, when used as a benchmark, shows that inventions of the present disclosure can achieve broadly similar overall mechanical properties.

TABLE 7
Characteristics of Exemplary Polyurethane Foams

Example Number

| | 6 | 7* | 8* |
|---|---|---|---|
| Polyol | 5 | 6 | 7 |
| Density (kg/m³) | 41.2 | NA | 44.9 |
| Ultimate Tensile Strength (kPa) | 208 | NA | 157 |
| Ultimate Elongation (%) | 152 | NA | 131 |
| Tg (DSC) (° C.) | −45 | NA | −27 |
| Tg (DMA) (° C.) | −33 | NA | −16 |
| Compression Set (Dry) (%) | 6.1 | NA | 9.9 |
| Compression Set (Wet) (%) | 9.1 | NA | 26.8 |
| Resilience (%) | 28 | NA | 24 |

*Comparative example
NA = Not Applicable

Polyurethane foams were successfully prepared at room temperature (23° C.) using Polyol 1 of the present disclosure as the polyol exists in liquid form at this temperature (Example 6). It was not possible to produce an elastomer at ambient temperature using Polyol 2 (comparative example) since this exists as a solid at this temperature and could not be poured into the reaction mixture (Example 7).

Polyol 4 (comparative example) is an example of a liquid polyester used commercially in the production of flexible polyurethane foams. The exemplary polyol of the present disclosure furnished more resilient materials than those produced using Polyol 4 (Example 8), demonstrated by the significantly lower glass transition temperature and ball rebound results. This was hitherto not possible due to the challenge of producing polycaprolactones in the liquid form. The example of the present disclosure also demonstrated marked improvement in hydrolytic performance, as indicated by the compression set in wet conditions. The underscores the value and industrial applicability of the inventions of the present disclosure.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the disclosure may be utilized in numerous combinations, all of which are expressly contemplated by the present description. These additional aspects and embodiments are expressly included within the scope of the present disclosure. The publications and other materials used herein to illuminate the background of the disclosure, and in particular cases, to provide additional details respecting the practice, are incorporated by reference.

Thus, those skilled in the art will recognize, or be able to ascertain using no more than routine experimentation, many equivalents to the specific embodiments of the disclosure described herein. Such equivalents are intended to be encompassed by the following claims. It is understood that the detailed examples and embodiments described herein are given by way of example for illustrative purposes only, and are in no way considered to be limiting to the disclosure. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

What is claimed is:

1. A polymeric composition comprising, consists essentially of, or consists of a reaction product of:
(a) one or more polycaprolactone co-polyol, wherein the one or more polycaprolactone co-polyol comprises, consists essentially of, or consists of a reaction product of one or more hydroxyl-functional organic compound with ε-caprolactone and one or more ε-caprolactone with one alkyl substituent, wherein
the one or more hydroxyl-functional organic compound is present in the range of about 5.0 wt % to about 95.0 wt %,
the ε-caprolactone is present in the range of about 5.0 wt % to about 95.0 wt % of the total molecular weight of the polycaprolactone co-polyol,
the one or more ε-caprolactone with one alkyl substituent is present in the range of about 5.0 wt % to about 95.0 wt % of the total molecular weight of the polycaprolactone co-polyol, and
the one or more polycaprolactone co-polyol is present in the range of about 5.0 wt % to 95.0 wt % of the polymeric composition and has an average molecular weight of about 500 g/mol to about 10,000 g/mol;
(b) one or more diisocyanate that is present in the range of about 5.0 wt % to 95.0 wt % of the polymeric composition; and
(c) optionally at least one of one or more diol chain extender, one or more diamine chain extender, or a combination thereof, having a molecular weight of about 60.0 g/mol to about 600.0 g/mol, with an NCO:OH molar ratio of from about 0.9:1 to about 2:1, wherein the one or more diol chain extender, the one or more diamine chain extender, or the combination thereof is present in the range of about 0.0 wt % to 25.0 wt % of the polymeric composition.

2. The polymeric composition of claim 1, wherein the one or more ε-caprolactone with one alkyl substituent comprises or is at least one of methylcaprolactone, ethylcaprolactone, propylcaprolactone, or a combination thereof.

3. The polymeric composition of claim 1, wherein the one or more ε-caprolactone with one alkyl substituent comprises or is at least one of 3-alkyl substituted caprolactone, 4-alkyl substituted caprolactone, 5-alkyl substituted caprolactone, 6-alkyl substituted caprolactone, 7-alkyl substituted caprolactone, or a combination thereof.

4. The polymeric composition of claim 1, wherein the one or more ε-caprolactone with one alkyl substituent is present in the range of about 5.0 wt % to about 50.0 wt % of the total molecular weight of the polycaprolactone co-polyol.

5. The polymeric composition of claim 1, wherein the one or more ε-caprolactone with one alkyl substituent is present in the range of about 5.0 wt % to about 30.0 wt % or about 5.0 wt % to about 20.0 wt % of the total molecular weight of the polycaprolactone co-polyol.

6. The polymeric composition of claim 1, wherein the one or more hydroxyl-functional organic compound comprises or consists of at least one of one or more tertiary carbon atom, one or more quaternary carbon atom, or a combination thereof.

7. The polymeric composition of claim 1, wherein the one or more hydroxyl-functional organic compound comprises or consists of one or more monol, one or more diol, one or more triol, one or more tetrol, or a combination thereof.

8. The polymeric composition of claim 7, wherein at least one of:
the one or more monol comprises or is at least one of one or more linear or branched fatty alcohol, methanol, ethanol, propanol, butanol, pentanol, hexanol, heptanol, octanol, nonanol, decanol, or a combination thereof;
the one or more diol comprises or is at least one of one or more, methanediol, ethanediol, propanediol, butanediol, pentanediol, hexanediol, heptanediol, octanediol, nonanediol, decanediol, 3-methyl-1,5-pentanediol, neopentyl glycol, or a combination thereof;
the one or more triol comprises or is at least one of one or more linear or branched fatty alcohol, methanetriol, ethanetriol, propanetriol, butanetriol, pentanetriol, hexanetriol, heptanetriol, octanetriol, nonanetriol, decanetriol, triethanolamine, trimethylolpropane, or a combination thereof;
the one or more tetrol comprises or is at least one of one or more linear or branched fatty alcohol, methanetetrol, ethanetetrol, propanetetrol, butanetetrol, pentanetetrol, hexanetetrol, heptanetetrol, octanetetrol, nonanetetrol, decanetetrol, pentaerythritol, or a combination thereof; or
a combination thereof.

9. The polymeric composition of claim 7, wherein at least one of:
the one or more monol comprises or is at least one of methanol, ethanol, 1-propanol, 2-propanol, 1-butanol, 2-butanol, 1-pentanol, 2-pentanol, 3-pentanol, 1-hexanol, 2-hexanol, 3-hexanol, 1-heptanol, 2-heptanol, 3-heptanol, 4-heptanol, 1-octanol, 2-octanol, 3-octanol, 4-octanol, 1-nonanol, 2-nonanol, 3-nonanol, 4-nonanol, 5-nonanol, 1-decanol, 2-decanol, 3-decanol, 4-decanol, 5-decanol, or a combination thereof;
the one or more diol comprises or is at least one of methanediol, 1,1-ethanediol, 1,2-ethanediol, 1,3-propanediol, 1,2-propane diol, 1,1-propanediol, 2,2-propanediol, 1,4-butanediol, 1,3-butanediol, 1,2-butanediol, 2,3-butanediol, 1,1-butanediol, 2,2-butanediol, 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, 1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2, 6-heptadiol, 3,3-heptadiol, 3,4-heptadiol, 1,1-heptadiol, 2,2-heptadiol, 3,3-heptadiol, 4,4-heptadiol, 1,8-octanediol, 1,9-nonanediol, 1,10-decanediol), 3-methyl-1,5-pentanediol, neopentyl glycol, or a combination thereof;
the one or more triol comprises or is at least one of methanetriol, ethanetriol, glycerol, butanetriol, pentanetriol, hexanetriol, heptanetriol, octanetriol, nonanetriol, decanetriol, triethanolamine, trimethylolpropane, or a combination thereof;
the one or more tetrol comprises or is at least one of methanetetrol, ethanetetrol, propanetetrol, butanetetrol, pentanetetrol, hexanetetrol, heptanetetrol, octanetetrol, nonanetetrol, decanetetrol, pentaerythritol, or a combination thereof; or
a combination thereof.

10. The polymeric composition of claim 1, wherein at least one of:
the one or more hydroxyl-functional organic compound comprises or is one or more polyol comprising or consisting of at least one of poly(tetramethyleneglycol), poly(propylene glycol), poly(ethylene glycol), polycarbonate polyol, or a combination thereof;
the one or more hydroxyl-functional organic compound comprises or is at least one of neopentyl glycol, trimethylolpropane, pentaerythritol, or a combination thereof;
the one or more hydroxyl-functional organic compound comprises or is at least one of neopentyl glycol; or
a combination thereof.

11. The polymeric composition of claim 1, wherein at least one of:
the one or more polycaprolactone co-polyol has an average molecular weight of about 500 g/mol to about 4000 g/mol;
the one or more polycaprolactone co-polyol is a liquid at about 15° C. to about 35° C. and about 0.0 to about 1.0 standard atmosphere (atm); or
a combination thereof.

12. The polymeric composition of claim 1, wherein at least one of:
the one or more polycaprolactone co-polyol has an average molecular weight of about 500 g/mol to about 4000 g/mol, about 500 g/mol to about 2000 g/mol, about 1000 g/mol to about 4000 g/mol, about 1000 g/mol to about 2000 g/mol; and
the one or more polycaprolactone co-polyol is a liquid at about 15° C. to about 35° C. and about 0.0 to about 1.0 standard atmosphere (atm).

13. The polymeric composition of claim 1, wherein the one or more polycaprolactone co-polyol has a ¹⁴C/¹²C ratio equal to or greater than zero.

14. The polymeric composition of claim 1, wherein at least one of:
the one or more diisocyanate comprises or is at least one of diphenylmethane diisocyanate, carbodiimide-uretonimine modified diphenylmethane diisocyanate, 4,4′-diphenylmethane diisocyanate, carbodiimide-uretonimine modified 4,4′-diphenylmethane diisocyanate, 2,2′-diphenylmethane diisocyanate, carbodiimide-uretonimine modified 2,2′-diphenylmethane diisocyanate, 2,4′-diphenylmethane diisocyanate, carbodiimide-uretonimine modified 2,4′-diphenylmethane diisocyanate, isophorone diisocyanate, bimethylene diisocyanate, trimethylene diisocyanate, tetramethylene diisocyanate, pentamethylene diisocyanate, hexamethylene diisocyanate, heptamethylene diisocyanate, toluene diisocyanate, naphthylene diisocyanate, cyclohexylmethane diisocyanate, dicyclohexylmethane diisocyanate, or a mixture thereof;
the one or more diol chain extender comprises or is an aliphatic diol or an aromatic diol;
the one or more diol chain extender comprises or is at least one of an alkylene oxide or glycol, ethylene glycol, propanediol, butanediol, pentadiol, hexanediol, heptadiol, dihydroxybenzene, di(hydroxyethyl)-hydroxyquinone, di(hydroxymethyl)-hydroxyquinone, di-(hydroxyethyl)-bisphenol A, or a mixture thereof;
the one or more diamine chain extender comprises or is at least one of diaminodiphenylmethane, dichloro-diaminodiphenylmethane, diaminobenzene, dimethoxy-diamino biphenyl, dimethyl-diamino biphenyl, diamino biphenyl, dichloro-diamino biphenyl, or a mixture thereof; or
a combination thereof.

15. The polymeric composition of claim 1, wherein at least one of:
the one or more diisocyanate comprises or is at least one of diphenylmethane diisocyanate, carbodiimide-uretonimine modified diphenylmethane diisocyanate, 4,4′-diphenylmethane diisocyanate, carbodiimide-uretonimine modified 4,4′-diphenylmethane diisocyanate, 2,2′-diphenylmethane diisocyanate, carbodiimide-uretonimine modified 2,2′-diphenylmethane diisocyanate, 2,4′-diphenylmethane diisocyanate, carbodiimide-uretonimine modified 2,4′-diphenylmethane diisocyanate, isophorone diisocyanate, bimethylene diisocyanate, 1,3-trimethylene diisocyanate, 2,3-trimethylene diisocyanate, 1,2-trimethylene diisocyanate, 2,2-trimethylene diisocyanate, 1,4-tetramethylene diisocyanate, 1,3-tetramethylene diisocyanate, 1,2-tetramethylene diisocyanate, 2,3-tetramethylene diisocyanate, 1,1-tetramethylene diisocyanate, 2,2-tetramethylene diisocyanate, 1,5-pentamethylene diisocyanate, 1,4-pentamethylene diisocyanate, 1,3-pentamethylene diisocyanate, 1,2-pentamethylene diisocyanate, 2,3-pentamethylene diisocyanate, 2,4-pentamethylene diisocyanate, 3,4-pentamethylene diisocyanate, 3,5-pentamethylene diisocyanate, 1,1-pentamethylene diisocyanate, 2,2-pentamethylene diisocyanate, 3,3-pentamethylene diisocyanate, 1,6-hexamethylene diisocyanate, 1,5-hexamethylene diisocyanate, 1,4-hexamethylene diisocyanate, 1,3-hexamethylene diisocyanate, 1,2-hexamethylene diisocyanate, 2,3-hexamethylene diisocyanate, 2,4-hexamethylene diisocyanate, 2,5-hexamethylene diisocyanate, 3,4-hexamethylene diisocyanate, 3,5-hexamethylene diisocyanate, 4,5-hexamethylene diisocyanate, 1,1-hexamethylene diisocyanate, 2,2-hexamethylene diisocyanate, 3,3-hexamethylene diisocyanate, 1,7-heptamethylene diisocyanate, 1,6-heptamethylene diisocyanate, 1,5-heptamethylene diisocyanate, 1,4-heptamethylene diisocyanate, 1,3-heptamethylene diisocyanate, 1,2-heptamethylene diisocyanate, 2,3-heptamethylene diisocyanate, 2,4-heptamethylene diisocyanate, 2,5-heptamethylene diisocyanate, 2,6-heptamethylene diisocyanate, 3,3-heptamethylene diisocyanate, 3,4-heptamethylene diisocyanate, 1,1-heptamethylene diisocyanate, 2,2-heptamethylene diisocyanate, 3,3-heptamethylene diisocyanate, 4,4-heptamethylene diisocyanate, toluene-2,4-diisocyanate, toluene-2,6-diisocyanate, 1,2-naphthylene diisocyanate, 1,3-naphthylene diisocyanate, 1,4-naphthylene diisocyanate, 1,5-naphthylene diisocyanate, 1,6-naphthylene diisocyanate, 1,7-naphthylene diisocyanate, 1,8-naphthylene diisocyanate, 1,4-cyclohexylmethane diisocyanate, 2,4-cyclohexylmethane diisocyanate, 3,4-cyclohexylmethane diisocyanate, 4,4-cyclohexylmethane diisocyanate, 4,4′-dicyclohexylmethane diisocyanate, 1,4-dicyclohexylmethane diisocyanate, or a mixture thereof;
the one or more diol chain extender comprises or is an aliphatic diol or an aromatic diol;
the one or more diol chain extender comprises or is at least one of an alkylene oxide or glycol, ethylene glycol, 1,3-propanediol, 1,2-propanediol, 1,1-propanediol, 2,2-propanediol, 1,4-butanediol, 1,3-butanediol, 1,2-butanediol, 2,3-butanediol, 1,1-butanediol, 2,2-butanediol, 1,5-pentadiol, 1,4-pentadiol, 1,3-pentadiol, 1,2-pentadiol, 2,3-pentadiol, 2,4-pentadiol, 3,4-pentadiol, 3,5-hexanediol, 1,1-pentadiol, 2,2-pentadiol, 3,3-pentadiol, 1,6-hexanediol, 1,5-hexanediol, 1,4-hexanediol, 1,3-hexanediol, 1,2-hexanediol, 2,3-hexanediol, 2,4-hexanediol, 2,5-hexanediol, 3,4-hexanediol, 3,5-hexanediol, 4,5-hexanediol, 1,1-hexanediol, 2,2-hexanediol, 3,3-hexanediol, 1,7-heptadiol, 1,6-heptadiol, 1,5-heptadiol, 1,4-heptadiol, 1,3-heptadiol, 1,2-heptadiol, 2,3-heptadiol, 2,4-heptadiol, 2,5-heptadiol, 2, 6-heptadiol, 3,3-heptadiol, 3,4-heptadiol, 1,1-heptadiol, 2,2-heptadiol, 3,3-heptadiol, 4,4-heptadiol, 1,2-dihydroxybenzene, 1,3-dihydroxybenzene, 1,4-dihydroxybenzene, 1,4-di-(betahydroxyethyl)-hydroxyquinone, 2,5-di-(hydroxyethyl)-hydroxyquinone, 2,3-di-(hydroxyethyl)-hydroxyquinone, 3,5-di-(hydroxyethyl)-hydroxyquinone, 2,5-di-(hydroxyethyl)-hydroxyquinone, 2,3-di-(hydroxymethyl)-hydroxyquinone, 3,5-di-(hydroxymethyl)-hydroxyquinone, 1,4-di-(betahydroxyethyl)-bisphenol A, 1,3-di-(betahydroxyethyl)-bisphenol A, 1,2-di-(betahydroxyethyl)-bisphenol A, 1,5-di-(betahydroxyethyl)-bisphenol A, 2,3-di-(betahydroxyethyl)-bisphenol A, 2,4-di-(betahydroxyethyl)-bisphenol A, 2,5-di-(betahydroxyethyl)-bisphenol A, 2,6-di-(betahydroxyethyl)-bisphenol A, 3,4-di-(betahydroxyethyl)-bisphenol A, 3,5-di-(betahydroxyethyl)-bisphenol A, or a mixture thereof;
the one or more diamine chain extender comprises or is at least one of 2,2′-diaminodiphenylmethane, 2,3′-diaminodiphenylmethane, 2,4′-diaminodiphenylmethane, 2,5′-diaminodiphenylmethane, 2,6′-diaminodiphenylmethane, 3,4′-diaminodiphenylmethane, 3,5′-diaminodiphenylmethane, 3,6′-diaminodiphenylmethane, 4,4′-diaminodiphenylmethane, 4,5′-diaminodiphenylmethane, 4,6′-diaminodiphenylmethane, 5,6′-diaminodiphenylmethane, 2,2′-dichloro-3,3′-diaminodiphenylmethane, 2,2′-dichloro-4,4′-diaminodiphenylmethane, 5,5′-dichloro-3,3′-diaminodiphenylmethane, 2,2′-dichloro-6,6′-diaminodiphenylmethane, 2,2′-dichloro-3,4′-diaminodiphenylmethane, 2,2′-dichloro-3,5′-diaminodiphenylmethane, 2,2′-dichloro-3,6′-diaminodiphenylmethane, 2,2′-dichloro-4,5′-diaminodiphenylmethane, 2,2′-dichloro-4,6′-diaminodiphenylmethane, 2,2′-dichloro-5,6′-diaminodiphenylmethane, 3,3′-dichloro-2,2′-diaminodiphenylmethane, 3,3′-dichloro-4,4′-diaminodiphenylmethane, 3,3′-dichloro-5,5′-diaminodiphenylmethane, 3,3′-dichloro-6,6′-diaminodiphenylmethane, 3,3′-dichloro-2,5′-diaminodiphenylmethane, 3,3′-dichloro-4,5′-diaminodiphenylmethane, 3,3′-dichloro-6,5′-diaminodiphenylmethane, 3,3′-dichloro-4,2′-diaminodiphenylmethane, 3,3′-dichloro-4,6′-diaminodiphenylmethane,4,4′-dichloro-2,2′-diaminodiphenylmethane, 4,4′-dichloro-3,3′-diaminodiphenylmethane, 4,4′-dichloro-5,5′-diaminodiphenylmethane, 4,4′-dichloro-6,6′-diaminodiphenylmethane, 4,4′-dichloro-2,3′-diaminodiphenylmethane, 4,4′-dichloro-2,5′-diaminodiphenylmethane, 4,4′-dichloro-2,6′-diaminodiphenylmethane, 4,4′-dichloro-3,5′-diaminodiphenylmethane, 4,4′-dichloro-3,6′-diaminodiphenylmethane, 4,4′-dichloro-5,6′-diaminodiphenylmethane, 5,5′-dichloro-2,2′-diaminodiphenylmethane, 5,5′-dichloro-3,3′-diaminodiphenylmethane, 5,5′-dichloro-4,4′-diaminodiphenylmethane, 5,5′-dichloro-6,6′-diaminodiphenylmethane, 5,5′-dichloro-2,3′-diaminodiphenylmethane, 5,5′-dichloro-2,4′-diaminodiphenylmethane, 5,5′-dichloro-2,6′-diaminodiphenylmethane, 5,5′-dichloro-3,4′-diaminodiphenylmethane, 5,5′-dichloro-3,6′-diaminodiphenylmethane, 5,5′-dichloro-4,6′-diaminodiphenylmethane, 6,6′-dichloro-2,2′-diaminodiphenylmethane, 6,6′-dichloro-3,3′-diaminodiphenylmethane, 6,6′-dichloro-4,4′-diaminodiphenylmethane, 6,6′-dichloro-5,5′-diaminodiphenylmethane, 6,6′-dichloro-2,3′-diaminodiphenylmethane, 6,6′-dichloro-2,4′-diaminodiphenylmethane, 6,6′-dichloro-2,5′-diaminodiphenylmethane, 6,6′-dichloro-3,4′-diaminodiphenylmethane, 6,6′-dichloro-3,5′-diaminodiphenylmethane, 6,6′-dichloro-4,5′-diaminodiphenylmethane, 1,4-diaminobenzene, 1,2-diaminobenzene, 1,3-diaminobenzene, 2,2′-dimethoxy-3,3′-diamino biphenyl, 2,2′-dimethoxy-4,4′-diamino biphenyl, 5,5′-dimethoxy-3,3′-diamino biphenyl, 2,2′-dimethoxy-6,6′-diamino biphenyl, 2,2′-dimethoxy-3,4′-diamino biphenyl, 2,2′-dimethoxy-3,5′-diamino biphenyl, 2,2′-dimethoxy-3,6′-diamino biphenyl, 2,2′-dimethoxy-4,5′-diamino biphenyl, 2,2′-dimethoxy-4,6′-diamino biphenyl, 2,2′-dimethoxy-5,6′-diamino biphenyl, 3,3′-dimethoxy-2,2′-diamino biphenyl, 3,3′-dimethoxy-4,4-diamino biphenyl, 3,3′-dimethoxy-5,5′-diamino biphenyl, 3,3′-dimethoxy-6,6′-diamino biphenyl, 3,3′-dimethoxy-2,5′-diamino biphenyl, 3,3′-dimethoxy-4,5′-diamino biphenyl, 3,3′-dimethoxy-6,5′-diamino biphenyl, 3,3′-dimethoxy-4,2′-diamino biphenyl, 3,3′-dimethoxy-4,6′-diamino biphenyl,4,4′-dimethoxy-2,2′-diamino biphenyl, 4,4′-dimethoxy-3,3′-diamino biphenyl, 4,4′-dimethoxy-5,5′-diamino biphenyl, 4,4′-dimethoxy-6,6′-diamino biphenyl, 4,4′-dimethoxy-2,3′-diamino biphenyl, 4,4′-dimethoxy-2,5′-diamino biphenyl, 4,4′-dimethoxy-2,6′-diamino biphenyl, 4,4′-dimethoxy-3,5′-diamino biphenyl, 4,4′-dimethoxy-3,6′-diamino biphenyl, 4,4′-dimethoxy-5,6′-diamino biphenyl, 5,5′-dimethoxy-2,2′-diamino biphenyl, 5,5′-dimethoxy-3,3′-diamino biphenyl, 5,5′-dimethoxy-4,4′-diamino biphenyl, 5,5′-dimethoxy-6,6′-diamino biphenyl, 5,5′-dimethoxy-2,3′-diamino biphenyl, 5,5′-dimethoxy-2,4′-diamino biphenyl, 5,5′-dimethoxy-2,6′-diamino biphenyl, 5,5′-dimethoxy-3,4′-diamino biphenyl, 5,5′-dimethoxy-3,6′-diamino biphenyl, 5,5′-dimethoxy-4,6′-diamino biphenyl, 6,6′-dimethoxy-2,2′-diamino biphenyl, 6,6′-dimethoxy-3,3′-diamino biphenyl, 6,6′-dimethoxy-4,4′-diamino biphenyl, 6,6′-dimethoxy-5,5′-diamino biphenyl, 6,6′-dimethoxy-2,3′-diamino biphenyl, 6,6′-dimethoxy-2,4′-diamino biphenyl, 6,6′-dimethoxy-2,5′-diamino biphenyl, 6,6′-dimethoxy-3,4′-diamino biphenyl, 6,6′-dimethoxy-3,5′-diamino biphenyl, 6,6′-dimethoxy-4,5′-diamino biphenyl, 2,2′-dimethyl-3,3′-diamino biphenyl, 2,2′-dimethyl-4,4′-diamino biphenyl, 5,5′-dimethyl-3,3′-diamino biphenyl, 2,2′-dimethyl-6,6′-diamino biphenyl, 2,2′-dimethyl-3,4′-diamino biphenyl, 2,2′-dimethyl-3,5′-diamino biphenyl, 2,2′-dimethyl-3,6′-diamino biphenyl, 2,2′-dimethyl-4,5′-diamino biphenyl, 2,2′-dimethyl-4,6′-diamino biphenyl, 2,2′-dimethyl-5,6′-diamino biphenyl, 3,3′-dimethyl-2,2′-diamino biphenyl, 3,3′-dimethyl-4,4-diamino biphenyl, 3,3′-dimethyl-5,5′-diamino biphenyl, 3,3′-dimethyl-6,6′-diamino biphenyl, 3,3′-dimethyl-2,5′-diamino biphenyl, 3,3′-dimethyl-4,5′-diamino biphenyl, 3,3′-dimethyl-6,5′-diamino biphenyl, 3,3′-dimethyl-4,2′-diamino biphenyl, 3,3′-dimethyl-4,6′-diamino biphenyl,4,4′-dimethyl-2,2′-diamino biphenyl, 4,4′-dimethyl-3,3′-diamino biphenyl, 4,4′-dimethyl-5,5′-diamino biphenyl, 4,4′-dimethyl-6,6′-diamino biphenyl, 4,4′-dimethyl-2,3′-diamino biphenyl, 4,4′-dimethyl-2,5′-diamino biphenyl, 4,4′-dimethyl-2,6′-diamino biphenyl, 4,4′-dimethyl-3,5′-diamino biphenyl, 4,4′-dimethyl-3,6′-diamino biphenyl, 4,4′-dimethyl-5,6′-diamino biphenyl, 5,5′-dimethyl-2,2′-diamino biphenyl, 5,5′-dimethyl-3,3′-diamino biphenyl, 5,5′-dimethyl-4,4′-diamino biphenyl, 5,5′-dimethyl-6,6′-diamino biphenyl, 5,5′-dimethyl-2,3′-diamino biphenyl, 5,5′-dimethyl-2,4′-diamino biphenyl, 5,5′-dimethyl-2,6′-diamino biphenyl, 5,5′-dimethyl-3,4′-diamino biphenyl, 5,5′-dimethyl-3,6′-diamino biphenyl, 5,5′-dimethyl-4,6′-diamino biphenyl, 6,6′-dimethyl-2,2′-diamino biphenyl, 6,6′-dimethyl-3,3′-diamino biphenyl, 6,6′-dimethyl-4,4′-diamino biphenyl, 6,6′-dimethyl-5,5′-diamino biphenyl, 6,6′-dimethyl-2,3′-diamino biphenyl, 6,6′-dimethyl-2,4′-diamino biphenyl, 6,6′-dimethyl-2,5′-diamino biphenyl, 6,6′-dimethyl-3,4′-diamino biphenyl, 6,6′-dimethyl-3,5′-diamino biphenyl, 6,6′-dimethyl-4,5′-diamino biphenyl, 2,2′-diamino biphenyl, 2,3′-diamino biphenyl, 2,4′-diamino biphenyl, 2,5′-diamino biphenyl, 2,6′-diamino biphenyl, 3,4′-diamino biphenyl, 3,5′-diamino biphenyl, 3,6′-diamino biphenyl, 4,4′-diamino biphenyl, 4,5′-diamino biphenyl, 4,6′-diamino biphenyl, 5,6′-diamino biphenyl, 2,2′-dichloro-3,3′-diamino biphenyl, 2,2′-dichloro-4,4′-diamino biphenyl, 5,5′-dichloro-3,3′-diamino biphenyl, 2,2′-dichloro-6,6′-diamino biphenyl, 2,2′-dichloro-3,4′-diamino biphenyl, 2,2′-dichloro-3,5′-diamino biphenyl, 2,2′-dichloro-3,6′-diamino biphenyl, 2,2′-dichloro-4,5′-diamino biphenyl, 2,2′-dichloro-4,6′-diamino biphenyl, 2,2′-dichloro-5,6′-diamino biphenyl, 3,3′-dichloro-2,2′-diamino biphenyl, 3,3′-dichloro-4,4′-diamino biphenyl, 3,3′-dichloro-5,5′-diamino biphenyl, 3,3′-dichloro-6,6′-diamino biphenyl, 3,3′-dichloro-2,5′-diamino biphenyl, 3,3′-dichloro-4,5′-diamino biphenyl, 3,3′-dichloro-6,5′-diamino biphenyl, 3,3′-dichloro-4,2′-diamino biphenyl, 3,3′-dichloro-4,6′-diamino biphenyl,4,4′-dichloro-2,2′-diamino biphenyl, 4,4′-dichloro-3,3′-diamino biphenyl, 4,4′-dichloro-5,5′-diamino biphenyl, 4,4′-dichloro-6,6′-diamino biphenyl, 4,4′-dichloro-2,3′-diamino biphenyl, 4,4′-dichloro-2,5′-diamino biphenyl, 4,4′-dichloro-2,6′-diamino biphenyl, 4,4′-dichloro-3,5′-diamino biphenyl, 4,4′-dichloro-3,6′-diamino biphenyl, 4,4′-dichloro-5,6′-diamino biphenyl, 5,5′-dichloro-2,2′-diamino biphenyl, 5,5′-dichloro-3,3′-diamino biphenyl, 5,5′-dichloro-4,4′-diamino biphenyl, 5,5′-dichloro-6,6′-diamino biphenyl, 5,5′-dichloro-2,3′-diamino biphenyl, 5,5′-dichloro-2,4′-diamino biphenyl, 5,5′-dichloro-2,6′-diamino biphenyl, 5,5′-dichloro-3,4′-diamino biphenyl, 5,5′-dichloro-3,6′-diamino biphenyl, 5,5′-dichloro-4,6′-diamino biphenyl, 6,6′-dichloro-2,2′-diamino biphenyl, 6,6′-dichloro-3,3′-diamino biphenyl, 6,6′-dichloro-4,4′-diamino biphenyl, 6,6′-dichloro-5,5′-diamino biphenyl, 6,6′-dichloro-2,3′-diamino biphenyl, 6,6′-dichloro-2,4′-diamino biphenyl, 6,6′-dichloro-2,5′-diamino biphenyl, 6,6′-dichloro-3,4′-diamino biphenyl, 6,6′-dichloro-3,5′-diamino biphenyl, 6,6′-dichloro-4,5′-diamino biphenyl, or a mixture thereof; or
a combination thereof.

16. The polymeric composition of claim 1, wherein at least one of:
the one or more diisocyanate comprises or is at least one of diphenylmethane diisocyanate, carbodiimide-uretonimine modified diphenylmethane diisocyanate, 4,4′-diphenylmethanediisocyanate, carbodiimide-uretonimine modified 4,4′-diphenylmethane diisocyanate, 2,2′-diphenylmethane diisocyanate, carbodiimide-uretonimine modified 2,2′-diphenylmethane diisocyanate, 2,4′-diphenylmethane diisocyanate, carbodiimide-uretonimine modified 2,4′-diphenylmethane diisocyanate, isophorone diisocyanate, 1,6-hexamethylene diisocyanate, toluene-2,4-diisocyanate, 1,5-napthylene diisocyanate, 4,4′-dicyclohexylmethane diisocyanate, or a mixture thereof;
the one or more diol chain extender comprises or is at least one of ethylene glycol, 1,4-butanediol, 1,6-hexanediol, 1,4-di-(betahydroxyethyl)-hydroxyquinone, 1,4-di-(betahydroxyethyl)-bisphenol A, or a mixture thereof;
the one or more diamine chain extender comprises or is at least one of 4,4′-diaminodiphenylmethane, 3,3′-dichloro-4,4′-diaminodiphenylmethane, 1,4-diaminobenzene, 3,3′-dimethoxy-4,4-diamino biphenyl, 3,3′-dimethyl-4,4-diamino biphenyl, 4,4′-diamino biphenyl, 3,3′-dichloro-4,4′-diamino biphenyl, or a mixtures thereof; or
a combination thereof.

17. The polymeric composition of claim 1, wherein the polymeric composition is a polyurethane elastomer, a thermoplastic polyurethane, a hot cast polyurethane elastomer, a cold cast elastomer, a polyurethane foam, a flexible polyurethane foam, a slabstock polyurethane foam, a moulded polyurethane foam, a microcellular polyurethane foam, a polyurethane dispersion in aqueous or organic media, a polyurethane adhesive, a one-component polyurethane coating, a two-component polyurethane coating, an additive manufacturing composition/resin, or a polyurethane sealant.

18. The polymeric composition of claim 1, wherein at least one of:
one or more polycaprolactone co-polyol is present in the range of about 40.0 wt % to about 70.0 wt % of the polymeric composition;
one or more diisocyanate is present in the range of about 30.0 wt % to about 60.0 wt % of the polymeric composition;
the one or more diol chain extender, the one or more diamine chain extender, or the combination thereof, is present in the range of about 0.0 wt % to about 15.0 wt % of the polymeric composition; or
a combination thereof.

19. The polymeric composition of claim 1, wherein the polymeric composition is a polyurethane elastomer.

20. A polyurethane elastomer, a thermoplastic polyurethane, a hot cast elastomer, cold cast elastomer, a polyurethane foam, flexible polyurethane foam, a slabstock polyurethane foam, a moulded polyurethane foam, a microcellular polyurethane foam, a polyurethane dispersion in aqueous or organic media, a polyurethane adhesive, a one-component polyurethane coating, a two-component polyurethane coating, an additive manufacturing composition/resin, or a polyurethane sealant, comprising or consisting essentially of the polymeric composition of claim 1.

21. A polyurethane elastomer, a thermoplastic polyurethane, a hot cast elastomer, a cold cast elastomer, a polyurethane foam, a flexible polyurethane foam, a slabstock polyurethane foam, a moulded polyurethane foam, a microcellular polyurethane foam, a polyurethane dispersion in aqueous or organic media, a polyurethane adhesive, a 1-component polyurethane coating, a 2-component polyurethane coating, an additive manufacturing composition/resin, or a polyurethane sealant, comprising or consisting essentially of the polymeric composition of claim 1, wherein the one or more polycaprolactone co-polyol has an average molecular weight of about 500 g/mol to about 10,000 g/mol.
